(19) United States
(12) Patent Application Publication
(10) Pub. No.: US 2014/0258405 A1
(43) Pub. Date: Sep. 11, 2014

(54) Interactive Digital Content Sharing Among Users

(71) Applicant: Sean Perkin, Los Angeles, CA (US)

(72) Inventor: Sean Perkin, Los Angeles, CA (US)

(21) Appl. No.: 14/197,617

(22) Filed: Mar. 5, 2014

Related U.S. Application Data
(60) Provisional application No. 61/773,069, filed on Mar. 5, 2013.

(51) Int. Cl. H04L 29/08

(52) U.S. Cl. CPC H04L 67/10
USPC 709/204

(57) ABSTRACT

Systems and techniques for sharing content associated with a common characteristic are described. A describe technique includes establishing communication among mobile devices sharing a common characteristic, each mobile device associated with a respective user, receiving from a first mobile device sharing the common characteristic (i) a video segment captured by the first mobile device, and (ii) a request to make the captured video segment available for viewing by other mobile devices with which communication has been established; receiving from a second mobile device sharing the common characteristic a request to view the captured video segment received from the first mobile device; and transmitting to the second mobile device the captured video segment received from the first mobile device.

### PRIORITY CLAIM

This patent document claims the benefit of the priority of U.S. Provisional Application Ser. No. 61/773,069, filed Mar. 5, 2013 and entitled “Interactive Digital Content Sharing Among Users.” The above-identified application is incorporated herein by reference in its entirety.

### TECHNICAL FIELD

This patent document relates to sharing digital content (e.g., video, audio, images, data or the like) among a group of users, for example, via a wireless network and the users' respective mobile devices.

### BACKGROUND

Smart devices—that is, mobile electronic devices that incorporate various functionalities such as phone services, e-mail, internet browsing, text messaging, still and video photography, or the like—have become ubiquitous. Consequently, a large majority of the population has available at most times a mobile device with which the user in question can capture data such as video of, and/or other digital content relating to, an event of interest. Once captured, the user can share the captured digital content by uploading it to another device (e.g., a desktop or laptop computer), a cloud-based storage or photo service (e.g., Dropbox or Picasaweb), and/or to a social networking site (e.g., Facebook).

### SUMMARY

This patent document describes an interactive digital content sharing system that, among other things, enables multiple users to share, wirelessly and potentially in real time, video and/or other digital content captured with their respective mobile devices. More generally, the system described herein relates to the manner of taking, recording, sharing and categorizing content data including any manner of video, audio, images and/or text over a secured wireless, WiFi or peer-to-peer network streaming in real time between mobile devices integrated through a database located on one or more servers that combine the content data with targeted e-commerce and advertising relationships. The system includes a front end user interface having video taking and network option controls and a back end database able to manage front end network option controls in addition to a set of predefined criteria, Global Positioning System (“GPS”) coordinates of mobile devices on the network, and third party data.

In general, one aspect of the subject matter described in this document may be embodied in systems, methods performed by data processing apparatus and computer storage media encoded with computer programs that include the actions of establishing communication among mobile devices sharing a common characteristic, each mobile device associated with a respective user, receiving from a first mobile device sharing the common characteristic (i) a video segment captured by the first mobile device, and (ii) a request to make the captured video segment available for viewing by other mobile devices with which communication has been established; receiving from a second mobile device sharing the common characteristic a request to view the captured video segment received from the first mobile device; and transmitting to the second mobile device the captured video segment received from the first mobile device.

In general, another aspect of the subject matter described in this document may be embodied in systems, methods performed by data processing apparatus and computer storage media encoded with computer programs that include the actions of establishing communication with a central computer system configured to facilitate sharing of video segments among a plurality of mobile devices having a common characteristic; and performing either or both of the following functions: (a) using a video capture function of the mobile device to capture a video segment and transmit the captured video segment to the central computer system for real time, or near real time, viewing by other mobile devices sharing the common characteristic; and (b) requesting from the central computer system to view in real time, or near real time, a video segment captured by another mobile device sharing the common characteristic.

In general, another aspect of the subject matter described in this document may be embodied in systems, methods performed by data processing apparatus and computer storage media encoded with computer programs that include the actions of establishing communication with a computer system configured to facilitate sharing of video segments among a plurality of mobile devices having a common characteristic; using, when in a first user mode, a video capture function of the mobile device to capture a video segment and transmit the captured video segment to the computer system for real time, or near real time, viewing by other mobile devices sharing the common characteristic; and requesting, when in a second user mode, from the computer system to view in real time, or near real time, a video segment captured by another mobile device sharing the common characteristic.

One or more of the mobile devices may be a mobile device. The common characteristic shared by the plurality of mobile devices may be a common geographic region, which in turn may correspond to an event venue. The common characteristic shared by the plurality of mobile devices may involve participation in a predetermined activity, such as attending or viewing a live performance, and/or engaging in online activity relating to a common theme. The online activity may relate to a common theme such as one or more of online searching, sending email messages, sending text message, or engaging in social network activities. Receiving the request from the second mobile device and transmitting the captured video segment to the second mobile device may occur substantially in real time. One or more of the establishing, receiving, receiving or transmitting may involve sending and receiving data across a public or private network. Implementations can include providing advertisements to the plurality of mobile devices. A common characteristic shared by the plurality of mobile devices can include a common event. Implementations can include providing data to coordinate display of content on at least a portion of the mobile devices during a common event. Implementations can include providing a user interface to switch among a plurality of different content streams associated with the common characteristic for display on a screen, each of the content streams being captured by different mobile devices having the common characteristic. In some implementations, the different content streams can include video segments that provide different vantage points of a live event.

A system can include a processor configured to execute computer program instructions; and a computer storage medium encoded with computer program instructions that, when executed by the processor, cause the system to perform operations. The operations can include establishing communication with a plurality of mobile devices sharing a common characteristic, each mobile device associated with a respective user; receiving from a first mobile device sharing the common characteristic (i) a video segment captured by the first mobile device and (ii) a request to make the captured video segment available for viewing by other mobile devices with which communication has been established; receiving from a second mobile device sharing the common characteristic a request to view the captured video segment received from the first mobile device; and transmitting to the second mobile device the captured video segment received from the first mobile device.

In another aspect, a system can include a processor configured to execute computer program instructions; and a computer storage medium encoded with computer program instructions that, when executed by the processor, cause the system to perform operations. The operations can include establishing communication with a plurality of mobile devices sharing a commonality, each mobile device associated with a respective user; receiving from a first mobile device of the mobile devices (i) a captured content stream that is captured by the first mobile device and (ii) a request to make the captured content stream available for viewing by other mobile devices with which communication has been established; receiving from a second mobile device of the mobile devices a request to view content associated with the commonality; and transmitting to the second mobile device the captured content stream.

One or more implementations can include one or more of the following features. The commonality can include a common geographic region, common event venue, common activity, or a combination thereof. The operations can include providing advertisements to the plurality of mobile devices. The operations can include providing data to coordinate display of content on at least a portion of the mobile devices during the common event. The operations can include obtaining information from the mobile devices to determine the commonality.

Details of one or more implementations of the subject matter described in this document are set forth in the accompanying drawings and the description below. Other features, aspects, and potential advantages of the subject matter can become apparent from the description, the drawings, and the claims.

### DRAWINGS

FIG. 1 shows a representation of an example of a network environment.

FIG. 2 shows a representation of an example of a network-connected venue.

FIGS. 3A, 3B, 3C, and 3D show representations of exemplary screenshots on a mobile device.

FIGS. 4A and 4B show representations of exemplary screenshots on a mobile device.

FIG. 5 shows a block diagram of an example of computing devices that may be used to implement the systems and methods described in this document, as either a client or as a server or plurality of servers.

FIG. 6 shows a flowchart of an example of a server process.

FIG. 7 shows a flowchart of an example of a client process.

FIG. 8 shows an example of an architecture of a random bounce algorithm.

Like reference numbers and designations in the various drawings indicate like elements.

### DESCRIPTION

Life is filled with amazing experiences that are both fleeting and unique. These experiences can define and inspire a life and even change the course of history. Over the last century or so these experiences have been captured using the phonograph, telegram, telephone, camera & film, video & film, television, e-mail, digital cameras, digital videos and now the mobile device. It is only recently that humans have the ability to record and transmit simultaneously these experiences on a one-to-one or one-to-many basis. As the technology improves and costs fall in regards to bandwidth and hardware, the ability to share experiences with others can continue to become more common.

The mobile device can continue to revolutionize the world of communications unlike anything before. There is no longer the need to bury cables in order to communicate with one another. Cell towers have replaced telephone poles in much of the developing world. People can now share experiences!

Typically, a mobile device contains the ability to make calls, send e-mail, record video and take photos. Some mobile devices also make sharing digital content (e.g., videos, photographs, audio, etc.) possible. For example, a person can capture a video and then post it to a website such as Facebook or e-mail it directly to a friend. This process of sharing, however, is not instantaneous or otherwise in real time or even near real time. Typically, the convention sharing process requires multiple steps and effectively takes the user's attention away from the experience in an effort to share it.

In one sense, “youBounce” can be thought of as a system that includes an interface, database and control mechanism for the instant and simultaneous exchange (e.g., streaming) of digital content (e.g., video, audio, text, holographic, virtual) data in real time over secured wireless, WiFi and/or peer-to-peer networks among a host system and a plurality of users on their respective mobile devices. One aspect of the system is the interface, methodology and sequencing of events that allow the streaming to happen. In one respect, youBounce can be thought of as a controlling mechanism, and/or gateway for sending and receiving streaming data over public and/or private networks.

A person (equivalently, a user) using youBounce can capture and share experiences “in the moment.” Traditionally, a person would need to record a video and then share that video in a conventional, relatively cumbersome manner (e.g., using e-mail or uploading). In contrast, youBounce effectively is a system that allows both capturing and sharing video with others simultaneously. Thus, because the special moment or other captured experience is shared in real time, the attention is focused on the experience and not on the technology or other details of how the sharing is achieved. And, the captured moment or experience can be shared with one person, a few persons or many persons with equal ease in a random or specified pattern. Imagine a person making a movie. Typically, they would shoot the movie, process it, edit it then share it/show it on a screen. youBounce technology allows a user to make and share their movie as it's being made. It's as if—as an analogy—while shooting through a camera—the movie is simultaneously being shown on a (or a plurality) of screens. Additionally, the technology allows for multiple different entities to create, view and/or otherwise share movies simultaneously, leading to an infinite arrangement of shared experiences.

Specific reference is made herein to various implementation details of the youBounce system, examples of which are illustrated in the accompanying drawings. While the youBounce system is described with reference to various implementation details, the specific details are set forth for exemplary purposes and are not intended to be limiting.

In one aspect, youBounce may be implemented to include a system and methodology for creating, capturing, recording and sharing video, substantially in real time as the video is being captured, with either or both of specific and random targets (e.g., other users) over a secured network using mobile devices that transmit data over wireless, WiFi and peer-to-peer networks. In an implementation, youBounce may utilize a graphical user interface combined with a methodology for capturing, sharing and viewing data in a variety of formats and to a variety of devices operating on both Android and Apple iOS capable devices, and potentially with any other suitable platform as desired. In a sense, youBounce can be thought of as allowing users to capture video and then “bounce” (e.g., selectively stream substantially in real time) that video to random or specific targets. youBounce also allows users to record and store their respective digital content and/or other data to their mobile device as well as to a cloud-based network. youBounce's user interface may be implemented to seamlessly display the mobile device's video-taking capabilities over a network interface that allows a user to share with others at any time while capturing video.

For the sake of simplicity, clarity, robustness, and ease-of-use, youBounce's network aspect may provide users with various user interface controls (e.g., portrayed as a series of switches) that may be accessed through the interface and which provide users with various functions such as (1) connect to the youBounce network, (2) disconnect from the youBounce network, (3) “bounceIn,” which makes the user's currently captured video (i.e., corresponding to the light being received by the mobile device's lens) available on the youBounce network for viewing by others, (4) “bounceOut,” which allows users on the network to view incoming video (5) “bounceInRec,” which lets users who are taking video the option to allow others to not only view their video, but record and save it to their device or cloud account, and (6) “bounceOutRec” which allows users to record to their device or cloud account the incoming video of others.

In one configuration, the youBounce system may be implemented by having a server-side component (e.g., software executing on a computer system, which can include one or more server computers) and a client-side component (e.g., a client application that is installed and executes on the user's mobile device). Accordingly, generally speaking, the youBounce system can be used essentially by anybody with a mobile device that is able to download and install the client youBounce application. Typically, other prerequisites to using the youBounce system may include one or more of registering with the youBounce central computer system and paying appropriate fees such as licensing, registration, or usage fees.

In addition to the basic format of bouncing video in/out to others within the network, youBounce also may allow for several other manifestations of video capturing and sharing capabilities. For example, such capabilities may include the ability to bounce video to display monitors within public venues, bounce video to other devices in a coordinated pattern (for example, in a “wave” or in an “echo”), bounce video from one device to multiple devices simultaneously—called a bounce reflection.

The youBounce system may allow for video to be bounced within either or both a public and private setting, for example, in a public venue using a system of hardware including routers and servers and in a private setting using peer-to-peer connections in conjunction with public and/or private WiFi networks. Public venues can include both paid events such as concerts, sporting events and non-paid events such as red-carpets, charity events and parks, beaches and shopping malls.

The youBounce application utilizes a variety of algorithms to send/receive content such as video based on the type of transmission: random bounce, targeted bounce, bounceWave, bounceReflection, bounceEcho, bounceRetail and a bounceBig. The youBounce network may be organized via a back-end database that facilitates, through various network protocols, the ability to track the location of a mobile device in order to bounce video to it. Additionally utilizing GPS, a calendar of events, and location specific details, youBounce can automatically categorize any video into a library for easy search and reference. In addition, the youBounce system is tied into e-commerce and advertising capabilities. Using GPS, a calendar of events and location specific details, youBounce can specifically target and display a company's products and services for sale—all of which are integrated into either static or dynamic advertisements inserted between video's (bounces). These messages last between 2-6 seconds.

Recording capabilities of the youBounce system may allow for the recording of an event directly to a user's device, to a cloud-based repository, as well as simultaneously to a secured network. Recording features may include: record to a user's device or cloud account, allow recording by other users (random or specific) in the network, zoom and general video settings such as video resolution, ability to name a video, flash and more. The youBounce client application interface may provide user controls including zoom focal length and length of recording.

Interactive features of the youBounce system may include and allow a user to define a category of the video (e.g. a user can override the database auto naming function in both public and private settings and save any video as they desire e.g. “my video at the Beach,” or “Bob & Sarah at ‘concert’—‘concert’ being the name of an artist . . . ). When in a public setting, the database automatically names and categorizes the video in a more specific manner. This is achieved utilizing a back end database that utilizes a calendar of events, GPS coordinates and know functions of public and private spaces to code and name video(s). Essentially at any time, any user within the network can search for event that other users have made available on the youBounce network (e.g., videos that other users have “bounced in”) and thus view associated events as they are occurring. Optionally, the youBounce system may be implemented such that unless a first user allows other users to record the first user's streaming video, it may become no longer available once the first user ceases recording and sharing his/her video.

The youBounce system software allows for a plurality of users to simultaneously view the video of a single or multiple other users. The sequence if viewing video(s) by any user on the network is based on a random algorithm based on GPS coordinates, event type, category and location of users to other users. The youBounce system allows users to instantly scroll incoming video. More specifically, when a user is in bounceOut mode, they are watching an incoming video feed. This feed is either from a specific target (e.g. a friend) or a random target (any user within the defined algorithm). At any time a user can simply swipe their mobile devices screen from right to left to bounce to another video. Thus, a user can continuously view different videos as they occur with a single motion. This is in addition to searching videos. The length of a video being recorded to a user's mobile device is limited only to the storage capabilities of that device. The same is true of a user's cloud account. Additionally, the length of a video being viewed (bouncedOut) is limited only by the length of the video, or if being recorded, by the devices storage capability.

The youBounce system as described herein may be implemented, at least in part, as software code residing on mobile devices running, for example, Android or iOS software, controlled by an integrated database running on a network of servers, that allows a plurality of users the ability to create, share, control and view the flow of video, audio and text data in real time over secured wireless and WiFi networks in either a targeted or random manner among one another. Generally speaking, the system has four distinct elements:

The first element is an interface residing on a mobile device that allows users to capture data, such as video and/or audio data and record the captured data to the user's device. The interface includes a set of standardized controls for taking video including: stop, start, record, zoom, save, save as, send, length, size, quality and setup. Specifically the interface may include a primary button for recording video, a network button for sharing video and a swipe feature for viewing video.

The second element is a secured network that may be accessed by the user through the video interface through a user interface control (e.g., implemented as a “switch”) that allows a user or a plurality of users to control the recording, sharing and viewing of the data in real time to any combination of their device, the network, targeted users or random users of the network. The “switch” can take any of “on”, “off,” “in,” and “out” states and can be accessed at any time before, during or after a recording. The network is accessed through a system of routers, servers and peer to peer connections. The network can include private and public contacts, imported contacts from a user's device, Facebook, Twitter or other accounts and can include youBounce defined events and categories.

The third element is a database that defines, organizes, controls and pushes the data streaming over the network into a temporary library that is then combined and integrated with specific e-commerce and advertising categories. The database provides but is not limited to the GPS coordinates of the device (e.g., latitude and longitude), the type of content being recorded and viewed based on the GPS location and the integration of this content with targeted merchandise and advertising categories and sub categories. Users of the network can at any time access, view and purchase merchandise or advertisements within the interface.

The fourth element is a series of options for controlling and enhancing how the data is sent, received and viewed by other users, a plurality of users, the administrator or any combination thereof.

The manner in which the video is sent and received is called a “bounce.” The act of transmitting (e.g., streaming) a video to the network (e.g., so that it can viewed or otherwise accessed by others) is called a “bounceIn” or “Bouncing In.” The act of recording a video onto the network is called a “bounceInRec.” The act of viewing a video in the network is referred to as a “bounceOut” or “Bouncing Out.” The act of viewing and recording a video in the network is referred to as a “bounceOutRec.

There is a subset of “bounces” that may include BounceEvent, BounceReflection, BounceBig, BounceWave, BounceEcho, BounceChannels, BounceCloud, BounceBuy, BounceRetail, BounceNetwork, and BounceLocal. Other types of bounces are possible.

“BounceEvent” is a means of bouncing, including all subsets of bouncing within an organized venue. It is a default setting based on GPS coordinates and a scheduled event input into the database. The algorithm allows for, based on a pre-defined licensing agreement for bouncing only within or outside of the venue. For instance, an agreement with a promoter might only allow for the sharing of video between users attending the event (closed loop bounce). Or, the license could allow users to bounce video outside of the event (open loop) to anyone, anywhere. A Closed Loop is an environment in which communication between devices is limited to within a pre-defined location, GPS coordinates or license generated partnership. There can be multiple closed loops acting independently between one another. For example, there can be two locations, neither of which communicates with the other at this moment. An Open Loop can be created, for example, when two closed loops communicate with one another by sharing the same Network (connection). In this example, Location A and Location B share data within their own location (Network “Y”) and with one another through network “X”. In another example, multiple Closed Loops are communicating and interacting with other Closed Loops to form an Open Loop. Each Closed Loop has its own defined network name. In some implementations, every connection between Closed Loops has a common network name.

“BounceReflection” which is the act of sending video from a host device to many devices that record that data simultaneously. It is a subset of a “bounceEvent.” A bounceReflection can occur in a public or private venue. An example of a bounceReflection would be an artist on stage (the host) taking a video and that video being bounced (bounceInRec) to any and all mobile devices within the venue simultaneously. The host device notifies other devices utilizing the application regardless of their state (except for off). If a user's device is in bounceOut mode—the incoming stream is automatically played and any existing video is removed. If the user's device is in bounceIn mode—then a message is sent notifying the user of the incoming stream and gives them the option to view and record the hosts video.

“BounceBig” is the act of sending a video to an external monitor including a digital display such as a monitor, jumbotron or television equipped with the appropriate hardware and software. For example, a concert hall may have a very large display screen that can be seen by everyone within the hall. Depending on the licensing agreements with the property owner and promoter a user at the concert hall could have the ability to record video (bounceIn) to not only their mobile device and other mobile devices but also simultaneously to the monitor(s) at the concert hall. This feature works utilizing a series of network switches and algorithms (transmission, compression, video size, quality) that allow for the transmission wirelessly through a system of routers and servers within the venue.

A “BounceWave” is the act of randomly bouncing a user's video to other devices based on their GPS location in a predefined and scalable pattern. It is a subset of a “bounceEvent,” and requires multiple users to be successful. An analogy of a bounceWave would be akin to a physical wave created when a group of people at an event stand and sit in a coordinated pattern. This activity travels around the venue and can be physically seen by others as a rolling motion. As it relates to youBounce, a bounceWave is a coordinated display of data (bounceOut) buy multiple users who receive incoming data (bounceIn) from a single or a plurality of users as they relate to one another separated by distance (GPS location).

A “BounceEcho” is the act of randomly bouncing a user's audio to other devices based on their GPS location. It is a subset of a “bounceEvent.” It functions in the same manner as a bounceWave—however is strictly an audio event.

“BounceChannels” are a temporal library of pre-categorized and labeled videos based on either user defined values, GPS locations and pre-defined events. The video remain in the library either indefinitely or until removed by the creator of the video if a user selects to bounceInRec. Else, the video is streamed to the video library and remains there only as long as the video is being recorded.

“BounceCloud” is a means of privately storing a user's video. The video is accessible only by the user and his defined network (e.g., others users with whom the user desires to share his video collection, as specified via “BounceNetwork,” defined below). Any video that is taken by a user is automatically saved to the user's device, a cloud account, and/or both the user's device and cloud account.

“BounceBuy” is the means of purchasing merchandise either “on the fly” or from within the e-commerce store built into the application. For example, a user is attending a concert. The promoter “beams” an advertisement to the user to purchase a T-shirt of the artist currently on stage. A user can simply tap the ad to purchase the merchandise. This action notifies the database of the user's intent and sends the appropriate request to both the user and store at the event. The user at any time can go to the store, which can have the merchandise waiting. Payment can be done at the store or billed directly to the user's account.

“BounceRetail” allows users of the network to simultaneously “bounce Out” user defined and broadcast video from an organized event such as a concert in a retail setting such as a mall, store, street frontage or bus stop. The service also allows users to purchase merchandise. For example, a licensing agreement is established between an artist, promoter and network broadcaster for the rights to “stream” the event from users of youBounce as well as the broadcasters own “stream” which is HD quality outside of the venue. This action, in effect allows non-attendees to view the event from multiple perspectives, never before available. The sound and quality is determined by the broadcaster. While waiting for a bus, shopping at a mall—anybody with the application can (for a fee) view the event.

“BounceNetwork” allows users to select with whom they wish to share their video. The default setting is random based on location or event. In other words, unless a user specifically decides to only share video with a select person or group (can be defined in the moment or pre-defined from a user's contact list, address book or social media account such as Facebook), the application can share the video with others based on their GPS location or event.

“BounceLocal” allows users to bounce video outside of an organized event setting. For example, if a user was at a ski resort and they wanted to view video of others at the ski resort the application would automatically default to this setting as it knows the location (ski resort), the activity (sports) and the boundaries of the resort. Thus, all bouncedOut video would be limited to the local venue—the ski resort and a user would not get random video of non-location or related content.

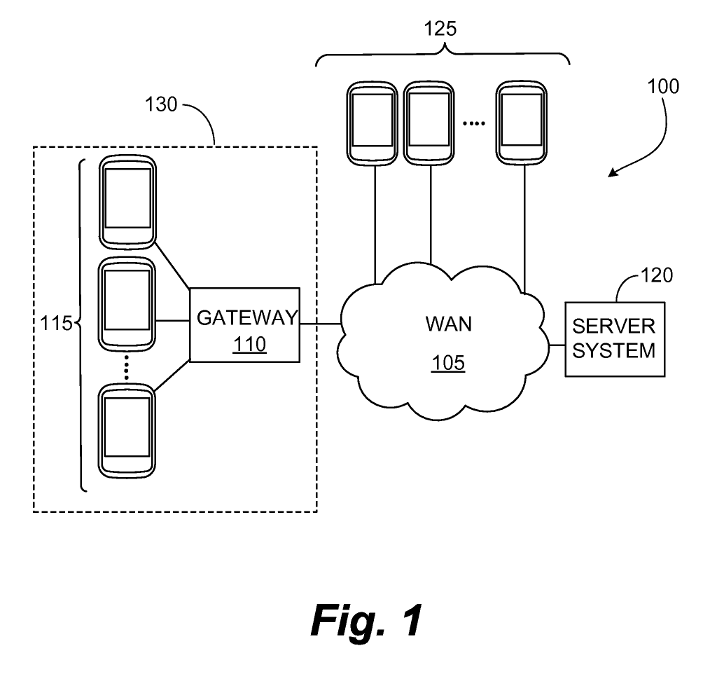

FIG. 1 shows a representation of a network environment 100 in which the subject matter described here may be applied. As shown, a wide area network (WAN) 105 provides backbone connectivity among a gateway 110, a server system 120 and two different groups of mobile devices, 115 and 125, respectively. The first group of mobile devices 115 share a commonality such as a common characteristic, for example, they may share a common geographic region such as an event venue or other locale, or they may be engaging in an activity having a common theme (e.g., performing similar online searches, engaged in social network activities, electronic messaging amongst each other, etc.). Using the systems and techniques described herein, the respective users of devices 115 can use those devices to capture and share video segments among each other locally, that is, within local area network 130. Alternatively, or in addition, video segments captured by one or more the respective users of devices 115 can be shared, via gateway 110 and WAN 105, with respective users of devices 125, who may or may not share the same common characteristic with devices 115. The server system 120 connected to WAN 105 can be used to control or otherwise manage, in whole or part, the backend operations involved in the sharing of captured segments among multiple users.

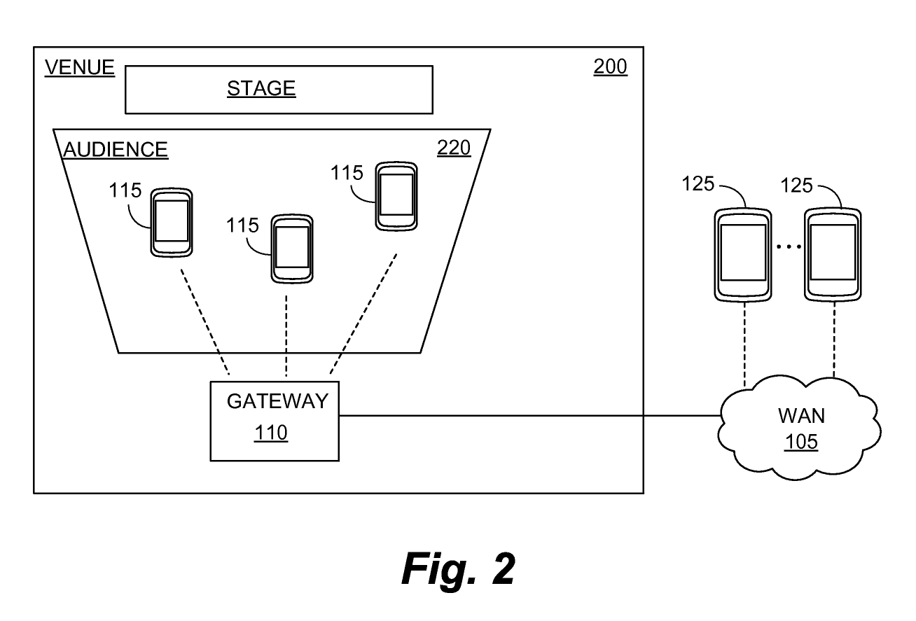

FIG. 2 shows a representation of a sample use case in which devices 115 share one or more common characteristics in that they are within the same venue 200 and are located in the audience region 220 viewing the same event, e.g., a live performance occurring on stage 210. Using the systems and techniques described herein, the respective users of devices 115 can capture content such as audio-only, video, or still images of a portion of the live performance occurring on stage 210 and share the captured segment with other devices 115 located within the audience region 220, thereby enabling one audience member to experience the live performance from the perspective of another audience member. Alternatively, or in addition, captured segments can be shared (via gateway 110 and WAN 105) with respective users of devices 125 located remotely from the venue 200, thereby enabling remote users of devices 125 to experience, from the perspective of an audience member in the venue 200, and potentially in real time or near real time, the live performance occurring on stage 210.

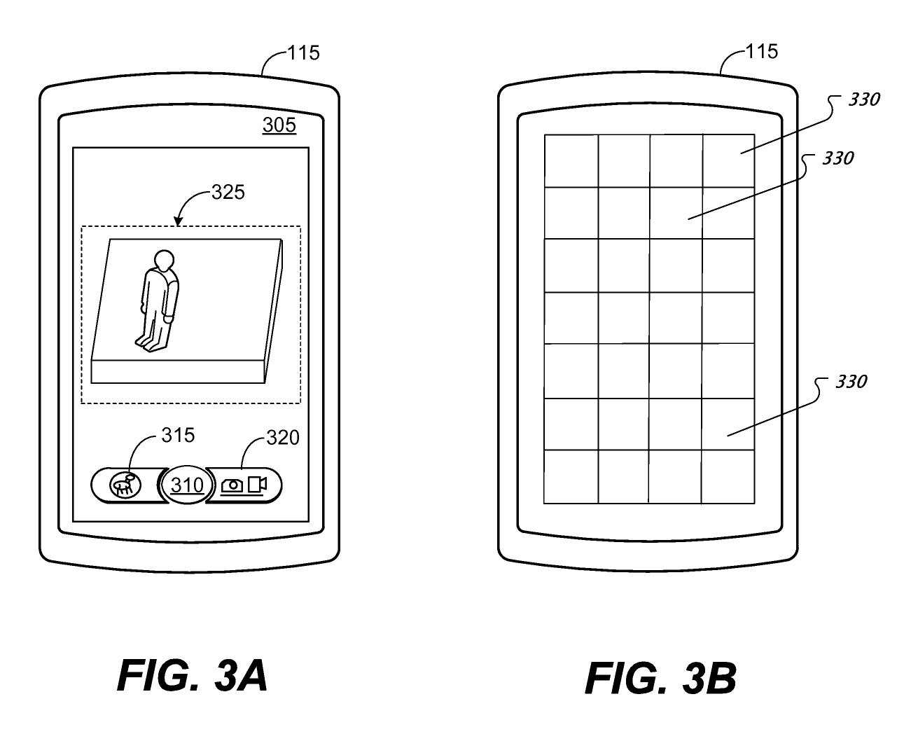

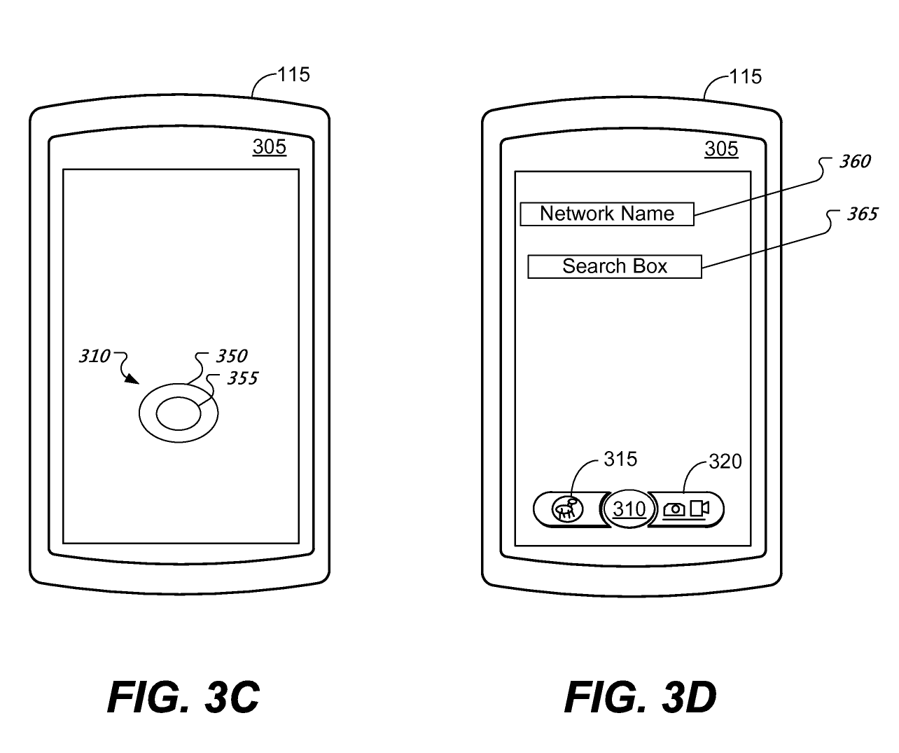

FIGS. 3A, 3B, 3C, and 3D show representations of screen shots on a mobile device depicting a simplified representation of aspects of a user interface that may be used to capture, share and view content such as audio, images, or video segments with others using the systems and techniques described here. As shown in FIG. 3A, a mobile device 115 having a touch-controlled display screen 305 depicts an image 325 of a scene being captured by a lens (not shown) of the device 115. In the state shown, the user of device 115 may have opted to “bounce in” meaning that the user is making available the captured image 325 (which may be still or video) for sharing with other users. In such a state, the user can opt to “bounce out,” thereby terminating the availability of his captured image 325 for sharing with other users. The user interface shown in FIG. 3A has a button 310, which can be referred to as a bounce button, to select a user mode. The user interface shown in FIG. 3A can include a control 320 (e.g., a slider) that enables the user of the device 115 to switch the content capture mode between still images and video images. In some implementations, content captured by a user is saved and accessible by the user. The content can be saved to a storage device within the device 115, network storage, or a combination thereof.

If in the state of FIG. 3A, the user selects control 315, the display may change to the state shown in FIG. 3B, in which multiple windows 330 (in this example, 28 individual windows) are displayed on the screen 305. Within each such window 330, a video segment captured by another device user can be displayed, thereby indicating that the displayed video is available for viewing by the user of device 115. To do so, the user of device 115 would simply select the desired window 330 and the screen display would change to cause the selected video to be displayed in a manner such that it occupies essentially the entire screen 305 of the device 115.

As shown in FIG. 3C, a mobile device 115 having a touch-controlled display screen 305 depicts a user interface such as a bounce button 310 by itself to select a user mode. In some implementations, the Bounce Button 310 is the primary means of recording content streams such as photos, data and video to the network. In some implementations, the button 310 includes two sections: an outer circle 350 and an inner circle 355. A User taps once to begin recording to the device 115 and to simultaneously streaming to other users within a specific network, which can be defined by event, location, category, or user name. The default color for button 310 is neutral. Once recording, the bounce button 310 changes to a glowing red. To allow others to simultaneously view and record a user's video, they tap two times on the bounce button 310. In some implementations, tapping again automatically stops the recording for all parties. When another user is viewing a video, the outer circle 350 changes color to green (being viewed) and/or red (being recorded). In some implementations, a color of the outer circle 350 informs a user when the content his is capturing is being viewed by others on the network by changing color from neutral (no views), to green (views but not being recorded) or to red (views and being recorded).

In some implementations, the bounce button 310 can dynamically float on the display screen 305. For example, upon opening a youBounce client application, the bounce button 310 can be centered on the screen 305 and enlarged. After a short interval, the bounce button 310 moves to the bottom of the screen 305, centered and is reduced in size. A user can tap on the bounce button 310 to begin capturing content; after which, the button 310 can move to the bottom of the screen 305, and the inner circle 355 of the button 310 can change color to indicate a recording status.

As shown in FIG. 3D, a mobile device 115 having a touch-controlled display screen 305 depicts an interface similar to the one depicted by FIG. 3A. In addition, the interface includes a display area 360 that shows a network name (if selected), and a box 365 for entering one or more search terms such as a network name, event name, or activity name. In some implementations, the network name is automatically selected and displayed in display area 360. For example, when a bounce is engaged, a network can be automatically selected by the youBounce application based on the GPS location of the device 115 and its relationship within a database to a posted event or non-event, or by the user who defines the network through a network name. For example, a user can create an ad-hoc network, provide a network name, and then create content specifically for that ad-hoc network. In another example, a youBounce server process can detect that device 115 is associated with an event, and provide a network name to the device 115 for display in area 360. In some implementations, the network name can include an artist name, promoter, tour information, date, time, or a combination thereof. In another example, a youBounce server process can detect that device 115 is within a specific geographical location, and provide a network name associated with that geographical location to the device 115 for display in area 360.

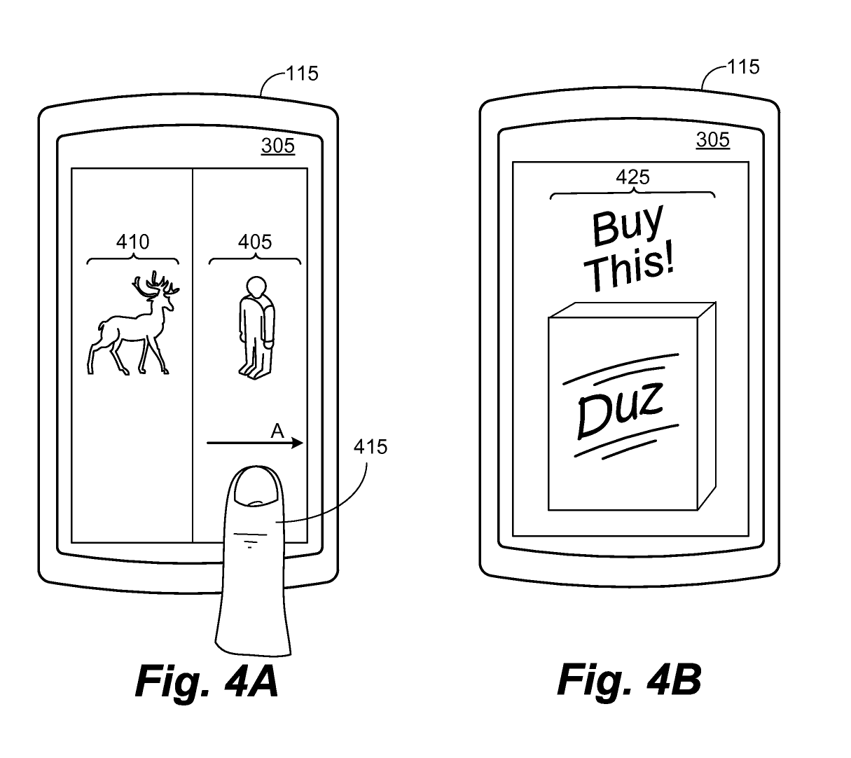

FIGS. 4A and 4B show representations of screen shots on a mobile device 115 depicting a simplified representation of additional aspects of a user interface that may be used to provide access to the functionality described herein. Assume that in the state shown in FIG. 4A, the user of the device 115 is in the mode in which the user is viewing videos shared by others connected to the network. Specifically, in the state shown in FIG. 4A, the user had been viewing a shared video corresponding to image 405 but has decided to move on and view other available videos. To do so, the user can simply sweep his finger 415 (or other pointer) across the screen 305 in Direction A, which can cause the display on the screen 305 to transition to a new image 410 corresponding to an available video associated potentially with a different other user on the network. The new image 410 can be selected in essentially any suitable manner (e.g., randomly, next in time, geographically closest user, etc.).

FIG. 4B shows a representation of a screen shot on a mobile device 115 in which an advertisement 425 or other message is being displayed to the user of the device 115. This state may be encountered by the user, for example, in between transitions from one shared segment to the next shared segment. In general, such advertising display represents one potential for monetizing the systems and techniques described here. Various other monetization techniques (e.g., time-based subscription fees, image-based fees, etc.) may be used instead or in addition to help monetize the system.

The user interface aspects depicted in FIGS. 3A-4B are merely exemplary of some of the potential user interface functionality and features that can be used. Other aspects are described herein.

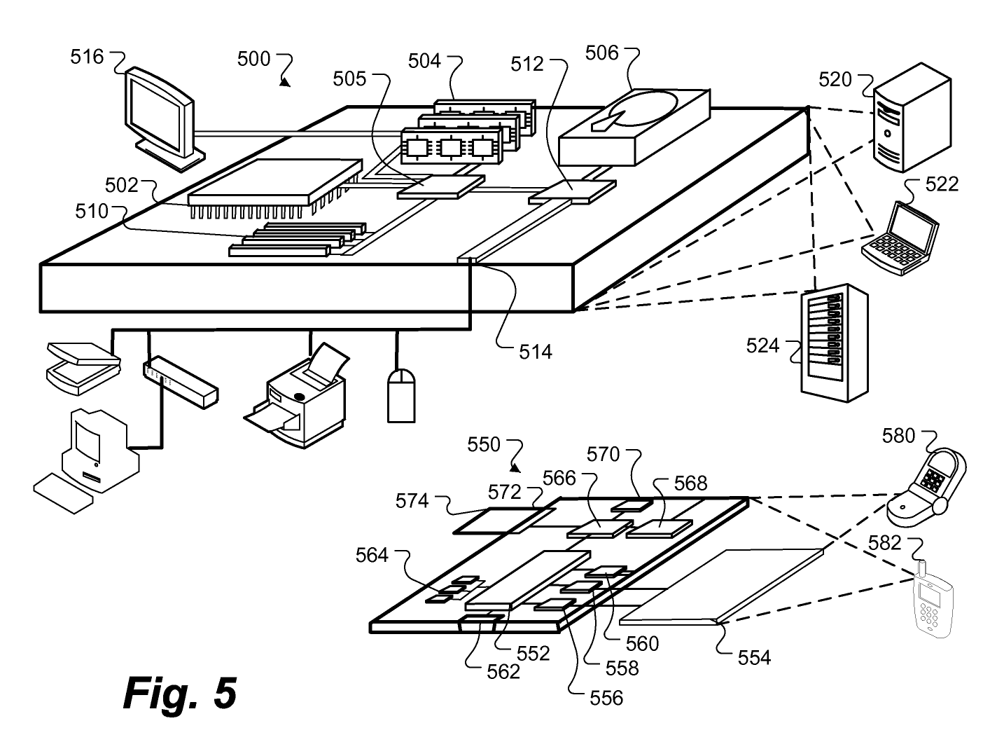

FIG. 5 shows a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. Additionally computing device 500 or 550 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as LTE, GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

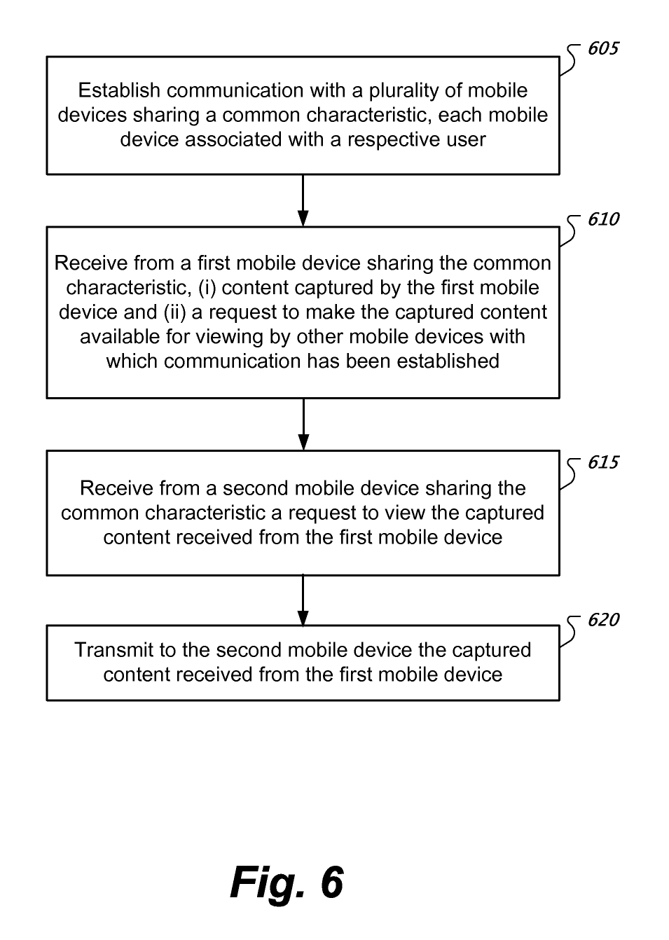

FIG. 6 shows a flowchart of an example of a youBounce server process. At 605, the process establishes communication with a plurality of mobile devices sharing a common characteristic, each mobile device associated with a respective user. At 610, the process receive from a first mobile device sharing the common characteristic, (i) content captured by the first mobile device and (ii) a request to make the captured content available for viewing by other mobile devices with which communication has been established. Various examples of captured content include images, video, audio, text, drawings, or a combination thereof. At 615, the process receives from a second mobile device sharing the common characteristic a request to view the captured content received from the first mobile device. At 620, the process transmits to the second mobile device the captured content received from the first mobile device.

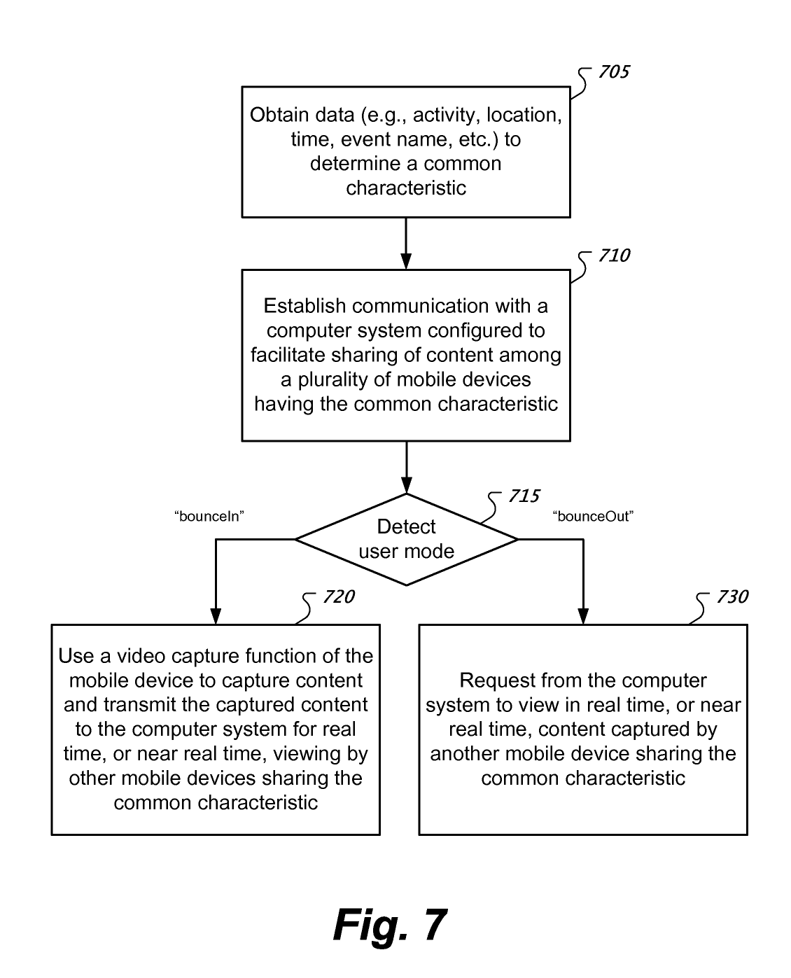

FIG. 7 shows a flowchart of an example of a youBounce client process. At 705, the process obtains data (e.g., activity, location, time, event name, etc.) to determine a common characteristic. Obtaining data can include accessing a location service on a mobile device, accessing a system time, retrieving information from a calendar service, retrieving information from a ticketing database, or a combination thereof. At 710, the process establishes communication with a computer system configured to facilitate sharing of content among a plurality of mobile devices having the common characteristic. At 715, the process detects a user mode. Detecting a user mode can include detecting a swipe across a display or a tap of a user interface button. If the user mode is in a bounceIn user mode, the process at 720, uses a video capture function of the mobile device to capture content and transmit the captured content to the computer system for real time, or near real time, viewing by other mobile devices sharing the common characteristic. If the user mode is in a bounceOut user mode, the process at 730, requests from the computer system to view in real time, or near real time, content captured by another mobile device sharing the common characteristic.

### Additional Examples and Implementation Details

The concept of youBounce is based on four principles. Firstly, that everything is somehow and in some way connected by distance, time or experience. The limiting factor being awareness. Secondly, that a conscious being is at all times experiencing something either created by themselves, with others, by others or through others separated by distance or time. The limiting factor being perspective as defined by distance, time and emotion. Thirdly, that the sum of Principles 1 and 2 can result in an experience being shared by any and all other conscious beings irrespective of time or distance. The limiting factors being choice (yes or no) and ability (emotional connection and technology). Lastly, at any given time in any given moment a conscious being can choose to share in or within an experience with others because of an emotional attachment either through physicality or technology. The limiting factor being time, either present or delayed as shaping the power of the experience and thus emotional attachment.

The problem is instant connection of and to an experience in an emotionally and powerful way accessible to and by everybody in any given moment at any given time regardless of the distance to the experience. How do we share our experiences with others while they are at their most powerful?

The opportunity is thus to develop a technology that instantly captures and shares the human experience in its most powerful state—as it occurs. Metaphorically this means a technology that allows a human to literally and physically transport themselves and their experiences anywhere and everywhere simultaneously, limited only to those that choose to be a part of that particular experience. Technologically it means taking a variety of hardware and assembling it with newly devised software code in a manner conceived, copyrighted, trademarked and patented by YouBounce that allows humans to share their experiences in a new and extremely powerful manner using a combination of live video, audio and text.

youBounce assists humanity in capturing life moment by moment in a manner unlike video chatting, social media or the posting of videos to sites such as You Tube. With the assistance of a mobile device, servers, routers, wireless and WiFi networks, the aid of a simple and familiar video player/recorder interface and the addition of a button that allows users to “beam, stream, view and record” video, audio and text as its being created—into and out of the network, all combined and organized into a manually structured yet self-generating database, youBounce can take the human experience of sharing “experiences” to its most powerful level yet.

A Real World Example Of youBounce. You are at a Coldplay concert at the Hollywood Bowl in Los Angeles, Calif. The venue is an outdoor amphitheater that seats approximately 18,000. It is a beautiful evening. You are surrounded by people from all walks of life all in one location to experience one thing—Coldplay. However, everybody in attendance will experience much more than Coldplay. While some will experience Coldplay, others will experience the experience of Coldplay, and others the experience of others experiencing Coldplay. Some people will be in the moment. Some distracted. Some people will be dancing, others singing. Some people will be having a great time and others, not so much. While some are looking at the stage others will be looking at others. In essence there will be in the span of the two hour event—hundreds of millions of experiences, some internal and others external. Regardless of the state of the experience there is by nature a collective consciousness at the event.

Based on the location (Hollywood Bowl), the audience (similar demographic and psychographic profile) and the subject matter (live pop music) it would be safe to assume that the majority of attendees have a device that allows them to record video. A smaller, however growing percentage of these users can have a mobile device. From the perspective of a person at the concert they can typically take a video when they're in the moment, experiencing a noteworthy moment (for themselves or to later share). And, at that moment, in the moment—it is all about them and their experience, be it filming themselves, the band, their friends, people down the aisle, the venue or anything else. Simultaneously to this action happening, there can be somebody else within the venue wanting to experience something other than what they're experiencing, or in other words—sharing in a moment. These are the people looking around, watching others, imagining what it would be like to be on stage, in the front row, next to the pretty girl dancing down the aisle, or the couple kissing behind them. Once the concert is over—almost all of these hundreds of millions of experiences are forgotten, lose their relevance or appear dim and unexciting relative to when they originally occurred. Herein is the opportunity of youBounce.

From a human perspective anybody at the concert who has the application can at any time opt to take a video and bounce it into the network to be seen by people—either preselected, random or a combination of both. Additionally, at any time anybody with the application can select to “bounce out” to the network and view the video and the experience of others in real time. Now, the person in the back row can in theory view the concert, at least for a moment by somebody front row center and vice versa. A person having an incredible time and who feels connected with everyone at the concert can take a video that can literally be seen, shared and experienced by everyone in attendance—so long as they in that same instance wish to share in that moment.

From a business and financial perspective the opportunity is bountiful. Imagine if the lead singer, Chris Martin in the middle of a song, picked up his microphone which is now a mobile device, pushed bounceIn and his experience was sent and recorded to every person's device. Thousands of people that opted to receive the video stream would now have in their possession the experience of experiencing Chris Martin's experience of the experience. This action can be monetized. It is called a bounceReflection.

During the 2 hour event there can be thousands of videos taken or “bouncedIn.” However, there can be potentially tens of thousands of videos viewed or “bouncedOut.” As a result of a variety of algorithms, a single video that is “bouncedIn” can theoretically be viewed by every device that is in a state of “bounceOut.” The more videos that are “bouncedIn” the greater the number of “bounce Out's.” At any given time a user who is in a state of “bounceOut” can swipe their device and bounce from video to video—a natural occurrence—in order to find an experience of relevance. Between every video that is bouncedOut is an insertion of an advertisement. In a single event there can potentially be hundreds of thousands of ads. This is called a bounceSponsor.

All of these ads are focused and targeted specific ads. If interested in the “nearly subliminal” and non-intrusive ad—a person merely taps the screen of their mobile device and the application can make note of their decision to purchase and/or participate either instantly or later. This seamless integration of advertising and user experience is designed to complement and not detract from the “in-the-moment” opportunity provided by youBounce. Because this is a public venue and a staged event the database is coded to allow for simple choices such as the delivery or pick-up at the venue of merchandise. Of course there is also the option at any time throughout the event for an interested party to tap the “event” button to find messages and promotions by sponsors of the event.

And, this is just the beginning. Future updates of the application can allow users at staged events to bounce their videos to large monitors thereby allowing all in attendance to view the concert in dramatic fashion from the perspective of an attendee. This is called a bounceBig. A bounceWave can allow users to bounce, scale, shrink and pattern video into shapes and waves in a coordinated manner, similar to a physical wave created and experienced by people at a concert or sporting event. A bounceEcho is similar to a bounceWave but involves the manipulation of sound across devices. With the integration of a database that includes event specific data and gps coordinates of subscribers anybody anywhere in the world could search the sites bounceChannels using keywords like “Coldpay, Chris Martin, Hollywood Bowl, concerts now” and even the name of another user they know at the event and up would come video as it occurring during the event.

In some implementations, youBounce is a subscriber based service that allows in its most basic format the ability to transmit video between mobile devices in real time. While one person is recording video via his mobile device, another person can be viewing that same video on his mobile device as it is being recorded. The service is a portal that allows the sharing of experiences between specific and/or random subscribers. These experiences at the option of the subscriber can be shared as they occur never to be seen again or recorded and saved in perpetuity. youBounce does this utilizing hardware including servers, mobile devices and routers communicating through wireless, WiFi and peer to peer networks in combination with software consisting of an interface and complex algorithms, all integrated into a database that has the ability to code the data based on a pre-defined set of criteria.

It is different from all other video and network applications in the market based on the company's philosophy of “the power of in-the-moment experience,” the interface in which users can share, save, record, erase and organize their video experiences, the relational functionality of the database to subscribers, their experiences and shared experiences between subscribers. It is different in its simplicity of the interface—push to record, swipe to view.

A subscriber merely needs to feel as if the video they're about to or are taking is worth sharing and in that moment merely tap “bounceIn” to share it with others. Others can include Everyone, Best Friends, Friends or any combination of the three as defined by a subscriber's existing contact database, Facebook friends, Google circle or custom selection defined within youBounce. Simultaneously, a subscriber who has stopped taking a video can at any time view video by others instantly and without having to do anything more than swipe “bounceOut” to go from video to video. The content of that video is determined by an algorithm that assumes a complex set of functional relationships including location, time, event and category.

The primary goal of youBounce as a service is to provide a safe and secure environment for sharing instant data such as streaming video. The network services operate within the background of the product interface and can be activated or de-activated on-the-fly at any time before, during or after a recording. Users of the service retain complete control of their videos and can determine who within the network can view or save them. Video that is streamed over the network is temporal in nature and not saved to the network unless dictated by a user. In other words it is only available at the moment it is taken. There are exceptions to this including a forced recording allowed by a subscriber which can remain on the network (public or private) until removed or a recording sent to a specific user not currently on the network which can remain active for up to 24 hours before.

From A Conceptual Point of View. Theoretically, everything in the universe is connected. An experience in one location of the universe can be shared elsewhere in the universe. A moment in the universe can depending on the perspective be shared as it occurs or some time later. There are over seven billion human beings on this planet and growing every day. At any given time a percentage of these billions of people can be having a similar experience or similar thought at the same time—but from a slightly different perspective. That perspective could be defined by a location or it could be a series of slightly different life experiences and location(s). That thought could be: “I'm in love.” “I'm happy.” “I'm scared.” “I'm hungry.” These thoughts and experiences are in effect a collective consciousness on an imperfect (human) level—as it is statistically highly unlikely that within our human lifespan all humans can have the exact same thought at the exact same time. Theoretically, however, it is possible.

If for instance there are 50,000,000 (0.71% of the population) people all over the world at the same time thinking “I'm in love” not only is there a thought energy created there is the potential for that energy to transform into mass. Realistically speaking this means that the thought energy is transferred into an act of love though this may not be the case 50,000,000 times. Furthermore, from a human psychological perspective if 50,000,000 people are in the moment experiencing this feeling of love (a common theme experienced by all including the subjects)—they are more inclined to share that feeling with others (transfer of energy) as it is occurring rather than at some later point in time when the experience has faded. Thus, the experience is at its greatest potential energy and thus power in the moment it is created.

Based on these encompassing theories: 1) that everything in the universe is connected 2) that an experience created in one part of the universe can be experienced anywhere and everywhere else within that exact instant 3) that the experience created, on the human scale can statistically and physically be felt or shared by others experiencing an exact but opposite experience elsewhere within existence . . . has evolved into the concept of youBounce.

YouBounce takes the notion that not only do similar people share similar experiences, different people share similar experiences. And, that these experiences are vital to the evolution of humanity as they provide a sense of both an individual identity (as defined by difference between experiences) and a larger presence (defined as shared experiences). Additionally, YouBounce understands that at any given time there is a small percentage of the population sharing a near identical experience. And, a small percentage of people sharing these experiences will want to further share these experiences with others. Furthermore, an ever smaller percentage will actually share their experience physically (transfer of energy) via some form of technology be it a telephone, cellphone, video, e-mail, tweet, blog or direct broadcast. And, that those interested in that experience will naturally and intuitively just tune in at that time to experience that experience. Technologically speaking they will be informed of the experience by the ringing of a phone, checking a schedule or opening an e-mail. Additionally, an experience is real—only when it actually happens. Thereafter, it might seem real—but it is merely a recording (a thought, a memory or a physical recording of an event). Therefore, an experience as it occurs is most powerful when it's actually happening not when it's thought (processed) or shared later. Lastly, energy (power) that is distributed as it is created in its purest form is at its most powerful.

We as humans are all experiencing experiences at all times. Physically, esoterically, emotionally, scientifically and theoretically all these experiences experiencing experiences are in effect the same experience just from a different perspective (distance, time). To look at it from another angle all things are all things at all times except when they're not (perspective). On a human and individual level, this theory while interesting is rather meaningless as it is too grand a scale to comprehend and too “out there” to be relatable within the “real world.” Except when it isn't!

YouBounce brings these various principals into a physical reality using technology, logic and emotion. Allowing anybody with the technology to share in or out an experience while it's occurring is the foundation for the concept of bouncing (sharing experiences through streaming video, in one instance). Life is nothing more than a series of moments placed into a sequence of events and given meaning from the perspective of the person experiencing the moment. No two moments are ever the same. No two moments can ever be repeated. All moments can be shared. youBounce allows humanity share experiences by bouncing between them. The technology consists of hardware and software. The logic is a function of statistical probability and the emotion is the realization that humans need to be and feel connected to others through shared experiences.

An Example of youBounce in a Non Paid Public Environment. In some implementations, youBounce can allow for bouncing with a confined and designated environment by and between those in that environment. Some implementations can expand the service to allow not only subscribers of the network to bounce into and out of events from outside of the designated location, it can allow bouncing in and out from anywhere to anywhere using the same technology with the addition of a search feature and substantially more comprehensive set of network connections. To this end, YouBounce canallow anybody, anytime from anywhere to bounce.

A subscriber is at home, bored. In the past that individual would watch TV or surf the internet or interact with others through sites such as Facebook. Those interested in video would search You Tube. While these are all ways to remove the boredom and all are and have been revolutionary to the human experience they don't do what youBounce does.

A subscriber of youBounce would open the application on their mobile device from their home, for instance and in the search box type “Maui.” Within a millisecond a search using an algorithm would yield and store within the database all users currently in “Maui.” The algorithm would determine if those subscribers were in a state of bounceIn or bounceOut and their network setting (E, BF, F). The algorithm would them eliminate all but those devices currently is a state of bouncingInEveryone. The database would then randomly send one streaming video at a time to the subscriber at home. The application would queue additional streaming videos to be streamed until such time as the subscriber types in a new search, changes states or closes the application. The subscriber could at any time swipe their screen to scroll from video to video. Between each video is an advertisement in this instance relating to Maui such as travel & tourism, sunscreen, bathing suits, summer apparel, hotels, airline flights, macadamia nuts, lei's and other specific data relatable to Maui. If at any time the subscriber is viewing a video and it ends (due to the sender stopping video recording or changing states) a new video instantly appears.

That same subscriber can also search more specifically something related to “Maui.” For instance “Maui, ‘name’ golf course” to bring up devices located at that specific golf course. Or “Maui, surfing” which would bring up all devices located on beaches. In both these instances the searches are non-paid, non-timed, non-categorized events. As such the youBounce database is coded to know that the GPS coordinates of those devices are at a golf course, approximately where on the golf course they are located and the name of the golf course, upcoming tournaments (event specific, location specific, time specific and paid) if applicable. The database can then tailor ads between bounces accordingly. In the former, golf related products and services from national and regional companies as well as from the golf course itself which can advertise tee times, rates, discounts for youBounce subscribers. In the latter example, using the same methodology the database would know the name of the beach based on GPS coordinates and would be able to provide information and advertising accordingly.

An Example of youBounce in a Non Paid Private Environment. A subscriber to youBounce is on the island of Maui at a beach taking a video of their kids. The moment is great and the subscriber wants to share it with only a select group of people—in this instance their best friends. While taking the video (the subscriber can opt to share the video before, during or after it has been taken) the subscriber taps on the network button and toggles until the bestFriends (BF) network appears.

The network button changes color which indicates to the subscriber that they are taking and sharing video with only their bestFriends. Unfortunately, only 2 of the 9 bestFriends are actually on the network at that particular moment. These two subscribers receive an income message regardless of the state of the application (other than off).

“Subscriber (name) is currently taking a private video and wants you to view it.” The 2 subscribers can accept or decline with a tap to either button. The remaining 7 subscribers who are not in the application are sent an e-mail as follows, “Subscriber A was taking video at “location” and wanted you to view it as it occurred. Unfortunately you weren't available. To view a copy of it tap here. You have 48 hours to view the video before it is removed from the network.”

The subscriber taking the video knows that 2 people (but not which ones) within their bestFriends network viewed the video (it states so on the interface and the network interface (semi sphere) bounceIn changes from green (sending video) to a green pulse (sending video+video is being viewed). The subscriber taking the video can also opt to record the video to the network for their bestFriends only. With this action the bestFriends not on the network would receive a message of an incoming video, however, they would be able to view the video anytime, including from the search box as it would be permanently saved to the youBounce network. At such time as the subscriber wishes to remove the video they can and it can no longer be available.

An Example of youBounce in a Non Event Paid Environment. A subscriber is in Aspen Colo. snowboarding. After a busy morning on the slopes they decide to take a lunch break. While eating lunch they wish to both amuse themselves as well as find out the best place to snowboard after lunch. They pull out their mobile device and bounceOut. They do not need to type in a keyword (they can but it's not required because the location is coded in the database as a public space, payment is required, mountain resort, skiing, snowboarding, etc.). The moment they bounceOut the algorithm automatically pulls all bouncedIn video within that defined location using gps coordinates. The subscriber can now watch video of people anywhere and everywhere on the mountain taking video. Not only is the subscriber being entertained—they are looking at video from all over the mountain and can make an assessment as to where the best snow is, fewest crowds or best terrain is—all based on simply watching a few seconds of video in a random sequence. No seeking, no searching, no fuss. It's a simple as opening the application and bouncingOut.

That same subscriber can also type into the search box—the name of another mountain or even a category of sport such as “snowboarding.” Anybody who has coded their video with the keyword “snowboarding” can come up in the results. The video can immediately begin playing.

In some implementations, youBounce works on two levels: firstly, a technological level and secondly on an experiential level. From a technological perspective in its simplest form youBounce is a video taking and sharing application that streams video created by either a single or plurality of users between mobile devices registered within a network and controlled by a database. Technically, the application employs very sophisticated algorithms to create these links is a pre conceived manner. These links are called “bounces” or “bouncing.” It requires a critical mass of user to function properly. The more users the more connections and the greater the experience is.

youBounce utilizes the following to work properly: software running on both Android and iOS platforms, a mobile device, a plurality of mobile devices, routers, servers, database, gps coordinates, identification of key landmarks, identification of paid events open to the public (public or private use), a unique user ID, wireless networks, Wifi networks, peer to peer networks, algorithms (movement, gravity, artificial intelligence, pattern recognition, connectivity), lens, microphone, monitor, tap technology, licensing agreements, merchandise, advertising, broadcast signal, hard drive, built in memory within a mobile device, subscription to the youBounce service, data plan with a provider, internet connection to download the application.

What is Bouncing? Bouncing refers to the act of streaming real time data such as video to either a specific or random source within a network. There are two primary states of bouncing. Bouncing in and bouncing out—collectively referred to as bouncing, or a bounce. Bouncing In (bounceIn) refers to the act of streaming live video into the network. Bouncing Out (bounceOut) refers to the act of viewing video within the network either streamed or delayed. Bouncing is the act of taking, viewing or recording video within the network. It is the primary action of the application and involves “switches” that allow Users to be Off, On, In or Out (bounce states) of the network. Bounces are randomly generated through algorithms and shared with other in the network. Others can refer to potentially everyone on the network or can be more targeted to include specific contacts or groups of contacts. Bounces can be very simple—from a regular bounce to very complicated—such as a bounceWave. There are various types of bounces.

Standard Bounce: The most basic method by which subscribers enter, exit and interact within the network. There is no limit to the number of subscribers that can view a single video simultaneously. The video that is seen is regulated by the source (either a specific or random target) in conjunction with an algorithm (based on location and category). Bouncing can occur in either a Public or a Private environment and either an organized event or non-organized activity.

bounceOn. Default state upon opening the application. Activates a subscriber into the network. A User can still be on the network and not be viewing or recording video—if their video application remains open it is in an Active (ON) state. A user can at any time record video as they normally would to their device and not share video into the network.

bounceOff. Default state upon exist of the application. Deactivates a subscriber out of the network.

bounceIn. Manual input by subscriber allowing video to be streamed into the network. To bounceIn a User taps the top half of the interface. The color goes from transparent to green. Anytime the Users takes a video (recording to their private device) other Users within the network are able to view this video. When a video is taken within the network by the User and others are viewing the video the color on the interface changes from green to a green pulse (top half of sphere).

bounceInRec allows video to be recorded into the network as it is streamed. A User can record their streaming video to the network and which allows other Users within the network to record to their device that particular video. To access this state a User taps (again) on the top half of the interface sphere and the color turns from green to red. The change of color informs the User of this action. When a video is recorded by a User (bounceOut) the User (bounceIn) is notified via a glowing red interface (bottom half of sphere). A User then goes about recording video as they normally would from their video device. Streaming video is saved—if recorded—to the device of the User who is in bounceOut mode. The number and length of the recording(s) is limited to the available storage capability of the device that is recording.

bounceOut. Manual input by subscriber allowing video to be viewed. The recipient of the video (bounceOut) is notified of incoming video via the interface color which goes from green to green glow (bottom half of interface). Who actually views this video is based on the algorithm which randomly bounces the video to others within the network. To rewind a video a User scrolls from left to right.

bounceOutRec. Allows an incoming video set to bounceInRec to be recorded if desired. Allows a User to view incoming video created by others on the network. To bounceOut a User taps on the bottom half of the interface sphere. The color turns green (active). Instantly video is fed to the Users device from other Users within the network. The video stream is random as calculated by an algorithm unless it is a Friend or bestFriend. The length of the stream can last as long as the video is streamed or until the viewer swipes to the next bounce. bounceOutRec allows a User to record the video they are viewing to their device. To record a video the User who is in bounceOut mode taps (again) on the bottom half of the interface and activates the bounceOut state. Once this action is complete the video stream is recorded to the Users (bounceOut) device. The length of the recording and number of recordings is limited to the available storage space on the Users device. Recording of streaming video across the network is saved to the User (bounceOut) device. The fully featured version can allow Users to automatically save their videos to the youBounceCloud. Saving to a User's device can require applicable protocols. Saving to the youBounceNetwork can require additional protocols that are to be determined.

Network Bounces: Bouncing within the network can be categorized into three subcategories. Everyone, Friends and bestFriends. A bounce to Everyone (E) is considered a public bounce and video can be seen by anyone and in theory everyone within the network. What video(s) a User on the network sees is calculated by a variety of algorithms. E is the default setting. This includes Friends and bestFriends. A bounce to Friends (F) is a semi private network and is akin to a Facebook page that allows viewing by any invitee. It includes bestFriends. bestFriends (BF) is considered a private network and is available to select contacts such as best friends, family member and loved ones. Friends (F) can be substituted for Family (F). Additionally a subscriber can create and name additional groups with the same security settings as Friends (F).

BounceEvent: There are two primary categories of events that can be bounced. Paid and non-paid. Each of these categories can have two sub scategories. Published and non-published.

A Paid Published event is any event that has an entrance fee and a scheduled date, time and location. This includes but is not limited to concerts, sporting events, festivals and special engagements. A Paid Non-Published event is any location that requires an entrance fee, a concentration of people but doesn't necessarily have a schedule (date, time) of something specific. Examples include amusement parks and ski resorts.

Until such time that youBounce is available in a private environment—bouncing an event is limited to that particular event. Meaning, a person at a concert will not have the ability to bounce outside of the event. Nor can a person outside of the venue have the ability to bounce into the event. This includes bouncing Friends and bestFriends.

bounceEvents are coded into the database with vital information about the venue, artist, date, time, address, venue statistics, category, sub category and key words. This allows for searching from anywhere at any time by subscribers.

A Non-Paid event is an event either published or not in which there is no entry fee. A published event would include for example a red carpet event, free concert or political rally. A non-paid, non-published event is a space where a high concentration of people is present that requires no entry fee. Examples include airports, malls, parks, universities and beaches.

An example of bouncing a paid and published event would be a concert. Everyone is there for the same primary reason—to see a performance. Random bouncing takes into account that the events is paid and published (specific date, time, location). It knows the category as defined in the database as a concert as well as the sub-category (genre of the concert), and keywords (artist names, band name, location name, song names, etc.). The algorithm can default the radius of all bounces to the perimeter of the venue. Algorithms regarding a targeted bounce would not be limited by the radius of the venue. Random bouncing is a pre-defined pattern set up within the database and customized to each venue. As such, the bounce pattern for a stadium (oval) would be different from a concert hall (rectangular). Patterns can include circular, square, linear and organic shapes. Additional algorithms allow the patterns to be sequenced (ebb & flow), pulse, random, radial, etc. The random pattern utilized by the algorithm evenly distributes the number of In and Out bounces amongst users on the network based on their location.

An example of bouncing a paid non-published event would be an amusement park. The algorithm in conjunction with the database knows by the subscribers coordinates that the location is a paid venue with entry at any time throughout the day and evening, the category is an amusement park and keywords include the name of the park, roller coaster, thrill rides, etc. and all are included within a defined GPS location which is adjusted automatically.

An example of bouncing a non-paid non published event would be a house party. The algorithm seeks out subscribers closest to the source (bounceIn) in a concentric pattern. Because the event (party) is not published and the location (private) is undefined—the algorithm makes an assumption that it is a small event and lowers the bounce radius from infinity to a few hundred feet. This algorithm set does not impact another algorithm set which allows for keywords that bring up video from within the search feature. The purpose of setting the algorithms up in this manner is to define and share a common level of interest amongst subscribers. A person at Disneyland would most likely want to view videos of other people at Disneyland as opposed to viewing a video of somebody at the beach.

Specialty Bounce—Bounce Wave: A bounceWave allows for full immersion of an audience between themselves and the artist. It is a digital version of a physical wave created at live events whereby people stand and sit in a coordinated fashion to create a wave that travels around the venue. However a bounceWave offers numerous features not attainable by the creation of a physical wave. This includes the ability to create multiple waves simultaneously, to expand and contract the size of a wave in an infinite array of patterns and to bounce both video and colors by and between subscribers. bounceWaves in effect engage the audience dynamically. They require group participation to be effective and can include a few people to the entire venue.

Specialty Bounces—Bounce Echo: A bounceEcho involves the transmission of sound over devices within a public venue to create interesting effects. It typically involves an artist pushing their voice to subscribers on the network. It involves a higher quality of sound than that found on a video recording. The bounce can be technically simple or very complicated and involve just a few people bouncing sound off their devices to the interaction of thousands of subscribers bouncing sound to an events sound system or an artist bouncing sound to individual devices.

Specialty Bounces—Bounce Reflection: A bounceReflection is a bounce in which one device can send its stream to all other devices within a specified event or venue. It requires administrative approval as the signal sends out a message about the incoming stream which is usually from a “star.” An example would be an artist on stage taking video and reflecting that video to every member in the audience who youBounce installed on their device.

Specialty Bounces—Bounce Big: A bounceBig is an additional paid service that allows subscribers to bounce their videos to monitors within a defined venue before, during and after a performance. As such a subscriber based on licensing agreements with venues and artists could watch their video (along with everyone else in the venue) on a billboard. While this can initially only be possible at staged events eventually it can be possible to walk down the street and bounce a video to an outdoor billboard that has the appropriate hardware.

Specialty Bounces—Bounce Store: A bounceStore allows subscribers to purchase products and services specifically targeted to a venue. While there is a large e-commerce store within the application—and a member of the site can purchase any product or service at any time using the search feature—the bounceStore takes a defined approach. The store changes products and services based on its location and if the location coincides with an event. For example a device located at a concert would display merchandise and discounts specific to that venue and artist. A device located at the beach would display products and discounts near the beach.

Specialty Bounces—Bounce Retail: A bounceRetail allows subscribers to view any event anywhere in the world on a large display with multiple feeds including a broadcast direct from the promoter or television network.

There can be multiple network protocol types on youBounce such as Public, Private, and Very Private. The public network is everyone on the service including Private and Very Private. As such, a subscriber that wishes to send video to everyone can also by default send to Private and Very Private contacts. A subscriber who wishes to send to Private can also send to Very Private by default. A subscriber who sends to Very Private can only send to this group. The public network—while theoretically consists of every subscriber on the network—relies on algorithms based on event, time, location, category and sub category to feed the appropriate video at the appropriate time. All networks are easily identifiable by a box, color and text. There is no import of contacts into the public network. youBounce allows subscribers to setup up networks based on their preferences. As such, a subscriber can import their contact from Facebook, Twitter, YouTube and Google in their current groups. They can then bounce or bounceRecord to any of these groups with a single tap. The private network has two default groups: Family and bestFriends. Importing can be done manually in addition to downloading data from other accounts. Users can also add or create a group. The procedure is standardized and is the same for importing data based on current industry standards and UI. At any time a subscriber can select a group to bounce to or a particular subscriber within the group.

The youBounce application can include a front end and a Back End. The Front End graphical user interface of youBounce is designed with two elements. The first element is the video interface. This video interface can differ slightly based on the mobile device in which the application is installed. The objective is to mimic the actions and sequences that a user is familiar with on their device without infringing on a manufacturers trademark and copyrights. As such, the video interface on a Samsung device can be slightly different than that of a Motorola. The second aspect to the interface is the network graphic that resides on a layer over the video interface. The two are seamlessly integrated. The network has a primary graphic by which a subscriber can share and receive data. There is also a menu feature to access other options with the application.

The back end interface, in some implementations, is not available to and cannot be seen by Users on the network other than the administrator. The GUI consists of a database with fields as well as appropriate UI to manage and service the application. There is limited access to advertisers, event promoters, property owners and licensees. Database segments can include User Information (unique ID #, user name, e-mail address, phone number, date of birth, password, billing information and mailing address); Advertiser & Sponsorship Information (unique ID #, user name, e-mail address, phone, fax, alternative number, password, billing and fulfillment information, ad campaign, dollars invested, dollars used, dollars balance, venue data and user data as it relates to the advertisements—how many people viewed, downloaded, interacted, purchased . . . ); Promoter Information (unique ID #, user name, e-mail address, phone, fax, alternative number, password, billing and fulfillment information, advertiser & sponsorship data, venue data, category, sub category, keywords, venue information; Venue Information (unique ID#, address, contact, bio, seating capacity, calendar of events); “Star” information (unique ID#, team name or artist name, roster of players, bio's, name of songs, relevant data to that artist or team, date of event, time, location); and information to quantify, analyze and break down all data into meaningful reports to be viewed by the company, advertisers, sponsors, promoters and venue operators.

A youBounce GUI can include the following features: bounceOn, bounceIn, bounceInRec, bounceOut, bounceOutRec, and bounceOff.

bounceOn: When the application is open bounceOn is active (bounceOnActive). Subscribers are registered tin the network and their coordinates are known. The category of their video is determined by knowing their coordinates (x, y, z, time) and if those coordinates coincide with an event registered in the database at that place and time. IF there is scheduled event the application can still determine the category (and keywords) of the video on a macro level based on the location. A subscriber knows they are in the network when the button interface is green.

bounceIn: A subscriber streams their video into the network. A video streamed into the network does not guarantee it can be viewed by other. The top half of the interface is green and turns into a green pulsing glow if another subscriber views the video. Length of video is determined by subscriber and/or the device they are recording on. The video is not saved to the network only to the subscriber's device. The exception would be if the target of a bounce is specific and not available. The recording can be temporarily saved to the network for 48 hours. The target is sent notification of a bounce via e-mail or text. “SubscriberName has sent you a bounce. Tap to view.” The link can open up the application. The interface can be glowing red then convert to a state of bounceOut. The video can automatically play. A bounceIn can be targeted or random. A random bounce is the default setting and can transmit the video using an algorithm to other subscribers on the network based on a predefined criteria set. A targeted bounce allows subscribers to send video to specific subscribers only.

bounceInRec: A bounceInRec has the same functionality as bounceIn with one powerful exception. A subscriber now can record not only to their device but to the network. Recording to the network allows a subscriber to save it to the cloud, place it in a channel and allows others to record it to their device. When this state is active the interface turns red—which reminds the subscriber of their choice to record it to the network. Though a subscriber has selected this option it does not mean that another subscriber or subscribers have recorded that video to their device or cloud account. When another subscriber or subscribers does opt to record another subscribers video they are notified of this recording by the interface changing from red to a red pulsing glow.

bounceOut: A subscriber who chooses to view videos on the network is said to be a state of bouncing out—bounceOut. A subscriber can receive an incoming video either randomly or specifically. A random video is received based on a set of predefined algorithms that take into account the relative position of a bounceOut to a bounceIn, the time and category of the video as defined by the database. A bounceOut video can last only as long as the subscriber taking the video. A subscriber can swipe their screen and scroll from video to video. In between every video and with each bounceOutSwipe is a 2-3 second advertisement.

bounceOutRec: During this state a subscriber has been given the ability to record a video (record a recording) to their device or their cloud account. During the recording the interface on the incoming recording device turns from red to a red pulse.

bounceOff: When a subscriber exits the application they are logged off the network automatically. Upon exiting an advertisement appears.

There are various types of bounces. Any event that is a public event with which YouBounce has a licensing agreement with the promoter, or property owner is registered within the database. Key data includes the date, time, location (coordinates), venue name, capacity, category of event, artist, team name, players and associated sponsors, advertisers and associated merchandise. It does not include events for which there is no published activity but tickets are required. Examples include an amusement park or a museum—which is referred to as a bounceLocation. When a subscriber attends a registered event the application defaults to the bounceEvent setting. This setting allows subscribers within the venue to only see other subscribers within the same venue. The exceptions are when a subscriber at an event selects to share video with a subscriber outside of the venue or when a subscriber outside of the venue searches for video from somebody within the venue.

The public network (Everyone) is the default setting upon opening the application. It is designated with an “E” and the color bronze. Included within the Everyone network are the Very Private (bestFriends) and Private (Friends) networks. As such if a subscriber chooses to bounceIn video to Everyone, their bestFriends (very private network) and friends (private network) are also included. Because the Everyone network is selected video bouncedIn in not necessarily going to be seen by bestFriends or Friends. However, the algorithm can favor that these networks have a higher probability of being bounced to.

Within the Everyone network a series of algorithm sets can determine who within the network views not only which videos but buy how many subscribers. Algorithms take into account gps coordinates, time, proximity of subscribers to one another, event as coded by the database and category of video. As such a video being bouncedIn from a college graduation in Los Angeles would most likely be bouncedOut not only to attendees of the event but to attendees of other graduations and subscribers who are on college campuses closest to the incoming video then outwardly in a concentric circle—globally.

All videos streamed within the Everyone network are automatically coded by their gps location and most logical category into bounceChannels. For instance a video shot at a mall would be categorized by keywords including “shopping,” “mall name,” “store(s) name.” A video taken at the beach would be categorized as: “beach,” “beach name,” “surfing,” “bikini,” “sandcastles,” or “waves” to name a few.

youBounce contains to private networks consisting of a Very Private Network (bestFriends) and a Private Network (Friends). Users who bounce video within the network to either of these networks are bouncing video to specified targets. Specific targets are created by subscribers either manually or by importing data from the devices contact list or third party sites such as Facebook, Google, You Tube or Twitter. When video is sent to specific targets a different set of algorithm sets are initiated and random targets are not included. Therefore if a subscriber wants to send a video to only a bestFriend they can be sure than nobody else in the network can see it. A subscriber that selects to send video to Friends can by default also send that same video to bestFriends, however, not the other way around.

Regardless of which private network is selected a subscriber can at any time toggle between contacts, add or deselect contacts. For example: a subscriber is taking a bounceIn video and has a total of 9 contacts in their bestFriends network but they want to share the video with only 5 of those contacts. To do this they would first select their bestFriends network (9 contacts) then deselect the 4 contacts they don't want to see the video. This new setting can remain in effect until the application is closed. Once re-opened all 9 contacts can reappear as bestFriends.

The primary difference between bestFriends and Friends has nothing to do with the privacy of the video being sent or viewed. It has to do with the number of viewers. bestFriends are considered the most important people in a person's life whereas friends might be friends, acquaintances or associates.

When would a subscriber want to be only on the private network? When they are not at a public event such as a concert or they want to send video that is of a confidential or personal nature or meant to be shared only with an intimate group of known contacts.

An example of a bounce in the private network. A subscriber is on vacation in Hawaii taking a video of their family on the beach. While taking the video (bounceIn) the subscriber decides to bounce it to all of the contacts in their bestFriends network. To do this a subscriber opens the application, starts recording video then taps bounceIn+bestFriends. Of these contacts some may or may not be on the network at the same time. Because the video is to a specific target the algorithm allows the video to be temporarily saved to the network for up to 48 hours. During that time all of the contacts have the ability to view the video. If a subscriber is not on the network they are sent an e-mail or a text notifying them of the video from “x.” A link allows them to automatically view the video. If a subscriber is on the network the video can automatically play. The subscriber taking the video can know that the video has been viewed (but not by whom—unless there is only 1 target) because the interface can turn from green to a green pulse. In the above example the subscriber might want to record the video to the network (bounceInRec—color is red). The video is recorded to both their device and to the cloud. The recipients know that they have the option to record the video to their device or their cloud storage because the interface (bounceOut) is red. If the recipient decides to record the video—the senders interface turns from red to a red pulse.

A youBounce application can include a private new group feature, similar to the Family and Best Friends feature, which can allow a subscriber to create groups as they desire. Groups can be imported from other contact lists and websites including e-mail, a users' device, Facebook, Twitter and others. Creating groups can be an import a manual procedure. Regardless, once the data has been input into the application a user can easily change setting. For example they can remove a contact from one group and add them to another group. The protocol follows existing application standards.

A youBounce application can include a bounceWave feature. A bounceWave works as follows. A subscriber at any time can select to start a bounceWave. The feature is available on the menu and appears only within a defined public space as noted in the database. The type of wave is pre-configured through an algorithm based on the shape and seating capacity of the venue. It also takes into account the number of subscribers active in the venue and their proximity to one another. As such there can be an unlimited array of patterns. Once a wave has been initiated by an audience member, the artist on stage or the promoter, a signal is sent to all other subscribers within the venue in a pattern and based on a time sequence. A subscriber's device can vibrate and an incoming message can appear inviting them to participate. Participants tap to select and their device is engaged. The software algorithm attempts to get users within a close geographic location to hold up their phone. Displayed on the device is a either video or color. The video increases or decreases in size as the number of devices are engaged or dis-engaged.

Any subscriber can initiate a bounce wave and there can also be numerous bounceWave's occurring simultaneously. As such a stadium event can have one coordinated wave or dozens of smaller waves. The software auto detects the rate of adoption by subscribers, location relative to other invitees and time to create the shape or image. A gravitational algorithm set is used to bring subscribers close to one another to join the bounceWave thus allowing the wave to form in a dense formation of subscribers. If no subscribers wish to participate then the bounceWave can naturally die out. Likewise—the more participants, the faster they join and their proximity to one another—the more powerful the wave.

An analogy of a bounceWave would be a digital version of a physical wave seen at an event. Human waves are started randomly by a single or group of attendees that stand in a vertical line and stand and sit in a coordinated sequence. The wave travels around the venue once or numerous times. Eventually the wave dies out. A bounceWave acts in the same manner but has many more options and patterns. Rather than people standing or sitting they merely hold up their devices once they have decided to participate in the bounceWave. A bounceWave requires group participation. Like a human wave it requires those around to participate. If there is minimal participation the wave dies out. Envision a stadium. If everybody was to hold up their device simultaneously the following could be possible: A single video (bounceIn) could be displayed on all devices. That feed could be a random feed from a single User or multiple Users. The incoming video can bounce from device to device and feature numerous incoming videos which bounce every 6-10 seconds. User A—seconds 1-6, User B seconds 7-12, User C seconds 13-20.

The video feed can come from the promoter or a combination of subscribers and the promoter. The video can be pre-recorded and come from a sponsor. There can be multiple waves occurring simultaneously. The video being displayed can be either static or dynamic and using algorithms can increase and decrease in size to accommodate the number of participants.

An example of a static video would be a single feed that is held steady over a set of participants. A video by a subscriber of the artist on a stage is then bounced to subscribers in the audience. The subscriber in the audience would see a reflection of the video taken by the subscriber of the artists on the stage across a predefined group of devices.

Dynamic video would be a single video feed moving across or through a set of participants. An example would be a subscriber taking a video of an artist on stage. That video is displayed on subscribers' devices however the video moves across devices in a set pattern such as concentric circles, linearly, or in an organic pattern (flower, starburst). Imagine a rectangle of subscribers (20×80). The video starts on the left and migrates to the right. If the video were 20 seconds long the Users on the extreme left (20 wide) would display the video for the first 4 seconds; seconds 5-9 would be the next 20 rows wide; seconds 10-14 would be rows 60-80; and seconds 15-20 would be the last 20 rows. Additionally, in the scenario above dynamic video can be programmed to move in an infinite number of sequences.

Aside from video, a bounceWave can include colors and patterns. A bounceWave can be initiated sequentially or randomly in different locations throughout a venue. Rather than linearly traveling around a stadium, a bounceWave can be circles that breathe in and out, x-patterns, flower shapes and/or any shape imaginable as defined by the applications software and protocols. These patterns and sequences can be programmed for optimization for a specific venue. Therefore, a stadium and an amphitheater would each be set to optimize a bounceWave. The signal spreads outward in a predefined pattern (circular, linear, organic) and invites more subscribers. Depending on which subscribers accept the invitation—the algorithm adapts to that location. Meaning if more subscribers to the west of the source participate in the bounceWave, the algorithm can naturally move west. If there are approximately an equal number of subscribers to the west and east—the algorithm can radiate in a linear pattern either west to east or east to west. If there are approximately an equal number of participants to the north, south, east and west then the algorithm can create a circular pattern.

Once a signal is sent to another User their device vibrates. A message appears “Join the bounceWave.” “Accept and hold up your device.” A User accepts the invitation by tapping on the screen. The interface turns blue. If a User opts not to join in they can deny the request, such as by simply ignoring it for three seconds or tap decline. The more subscribers who participate in the bounceWave, the larger the video display. As subscribers are added or dropped, the video image is recalculated and adjusted. In effect it grows and shrinks as well as dynamically moves across and around the venue. The video being displayed on subscribers devices' is continuously changed as the video feed randomly bounces from subscriber to subscriber.

Subscribers are randomly invited to share their video within the bounceWave by bouncingIn their video. Subscribers randomly receive a signal and their device vibrates. A message appears “Take a bounceWave video for all to see.” “Accept and start recording.” The interface turns blue and glows (video recording). The bounceOut video lasts between 4-6 seconds before bouncing to another User. The algorithm is continuously seeking out subscribers to both bounceIn (fewer) and bounceOut (many). All video in a bounceWave is saved to the network and stored for later usage. Everybody who participates within a bounceWave can have that event recorded to their device (subject to memory on the device).

Video feed includes graphics: youBounce logo, name, time, date and location of event; sponsorship video (3-10 seconds) with active link. A youBounce process allows subscribers to upload content to one or more social media sites such as Facebook, Twitter and You Tube accounts with one-touch access. A promoter of an event can also control and initiate a bounceWave. This includes feeding the bounceWave with video from their sources including live video of the event, the audience at the event, sponsors messages and non-affiliated video such as colors and patterns. In some implementations, a youBounce process can calculate the number of “seats” in a predefined venue, number of subscribers in the youBounce network within the venue, number of subscribers bouncingIn, number of subscribers bouncingOut, number of subscribers with default setting set to bounceWave, distance of subscribers to one another, or a combination thereof. The youBounce process then calculates the total number of subscribers immediately surrounding a bounceWave request, number of subscribers who are participating and adjusts the video being displayed based on the total number of subscribers. For instance: 1 video and 10 Users. The video is scaled from 1 to 2 to 3 to 4 to 5 to 6 to 7 to 8 to 9 to 10 devices. The youBounce process can disengage once a subscriber lowers his device and the total number of users participating is re-calculated.

A youBounce application can include a bounceBig feature. bounceBig allows subscribers in the network to reflect their video on 3rd party monitors such as jumbotrons, televisions, billboards and monitors. There are two phases 1) rollout of the service for live events and 2) ability for Users to bouceBig video in public spaces that are not prearranged. It is similar to the current methodology of event goers sending texts to billboards. A bouncebig works as follows: At any time during an event a subscriber can decide that they want to bounce their video onto a monitor. Depending on the license with the promoter and artists/team—this may or may not allow for this type of activity during the performance. The subscriber selects bounceBig and payment options. They have the ability to add text in addition to their video. Upon payment confirmation the subscriber receives a notice that at a certain time (pre-configured to avoid conflict with other subscribers) their device can buzz. Once the device buzzes they can have 30 seconds to take out their video and begin recording. Their recording can be seen by everybody in attendance. The length of their video is a minimum of 6 seconds and a maximum of 10 seconds.

A youBounce application can include a bounceEcho feature. A bounceEcho involves the transmission of sound across wireless devices in random and specific patterns. It is similar in concept to a bounceWave however involves only the use of sound and volume to create unique and unusual effects such as an echo, an increase or decrease in volume, balance, fade, base and treble effects. A bounceEcho is used in public spaces and requires the cooperation of multiple users within the network within close proximity to one another.

An example of a bounceEcho would be one hundred people in a 10×10 formation. A subscriber in the center of the square initiates a bounceEcho. The algorithm sends a message to users immediately next to the initiator to join in and then radiates the invitation outward. If all 100 people were to participate and hold up their device they would hear the audio from the initiator of the event as it travels in an outwardly radial pattern. The echo would ebb and flow in and amongst the group, similar to what one hears if they were to put their ear to a sea shell or change the sound from the left to right speakers.

A youBounce application can include a bounceCloud feature. The bounceCloud features allows subscribers to categorize and store (back-up) all videos as they occur for private and/or public use. It is used in conjunction with the bounceChannel feature set to either public or private view settings.

A youBounce application can include a bounceChannel feature. A bounceChannel is a feature for Subscribers within the network to share common themes as they pertain to video. As such, a subscriber taking a video at a rap concert could post the live video as they take it to a channel (Menu—Channel—Concerts—Rap) for others within and outside of the venue to watch at a later time. A Subscriber taking a video of their dog can post their live feed on a channel for dogs (Menu—Channel—Pets—Dogs).

A youBounce application can include a bounceRetail feature. Is only available within the vicinity of a retail kiosk or licensed retail outlet. A subscriber can be able to access any of the retail kiosks through their mobile device. The device can in addition provide a subscriber with locations near them. They can also search for a kiosk.

A youBounce application can include a bounceReflection feature. The concept of a bounce reflection is for a particular user to have the ability to contact all devices with the program loaded with the tap of bounceIn. The user is pre-designated as the superstar, e.g., “host”, and in a public setting such as a paid concert or sports venue can take a video from their vantage point and reflect it to all other devices. For example, a single device with a host designation can communicate with all other devices within a venue and bounceIn video to these devices. In some implementations, the bounceReflection feature can be a hidden feature and require a security password to access. This feature is reserved for the superstar, e.g., individual that others are there to see. At any time this individual—we can call the host—can activate this feature by opening up the application and tapping on settings and then bounceReflection. The host enters a password. The device then officially becomes the host device. The host can at any time take video as they normally would on the network—bouncingIn or bouncingOut. However, with this feature enabled the device communicates with all other devices within the venue and allows them to simultaneously see the video (bounceIn) from the host. As the host begins taking video (bounceIn) all other devices are notified with a vibration—regardless of their state (bounceIn or bounceOut). After the vibration a message appears “(“the host name” is taking a video. BounceOut to watch it.” All users who opt to tap and bounceOut can watch the video. It is also automatically recorded to their device with an advertisement at the end. The ability for the end user to record is limited to the amount of available storage they have on their device. Additionally, the recording is saved to the network for future marketing purposes. Just like a bounceIn and bounceOut the host must at all times know that they are not only bouncingIn or Out (glow of the interface) but they are Reflecting their video—which should be another color (I am envisioning that the entire UI sphere changes from gold/silver to another set of colors).

A bounceReflection in essence would be as if a famous person took a subscriber's device and recorded onto it themselves. It is the ultimate in personalization. An artist is on stage performing, for example. Prior to the performance they have entered the password and the device is setup for a reflection. Rather than the usual gold/silver the UI becomes blue/red. While performing they pull out their device and tap bounceIn(Reflection). The reflection is automatic as it was previously set up with a password release. They take video of themselves on stage or whatever they want. Within a split second all devices at the event are notified that the artist is taking a video. The devices vibrate and a message appears “xxx is taking video. BounceOut to watch it now.” As they watch the video it is automatically recorded to their devices (storage permitting). Once the artist's stops recording, an advertisement can be inserted and also recorded to a youBounce enabled device.

Once the application is downloaded a User is informed that they can receive five (5) minutes of free airtime before their subscription can need to be renewed. “Congratulations and Thank You for Joining youBounce. You can receive 5 free minutes. At any time you can add more minutes by acccessing the Menu.” “Refer a Friend and receive 5 more minutes for every Friend that joins.” To add friends—tap here.

User can tap on hot spot which direct them to select friends from either: The address book. Facebook. You Tube. Twitter. Similarly, when a User's account is running low on time—the system sends out a notification to remind Users they can need to renew their account.

In addition to standardized means of distribution the app can also be “pushed” to potential users through an e-mail and/or text notification and link. These notifications are typically by way of friends who want other friends to join them on the network. Friends can invite Friends through the Menu within the application. Downloading the application and joining the network is designed to be a simple and quick process involving only a few steps:

A youBounce application can include a panic button feature. The panic button allows a subscriber to report a dangerous situation or a violation of company policy. At any time during a bounceOut (viewing of video) a subscriber can tap the Panic button to immediately terminate the video feed. The video can also immediately be terminated by swiping to another video or changing the bounce state. The difference however is that when a subscriber selects the Panic button the administrator is sent a notification as is the incoming video. This notification is logged within the database under both recipient and sender. If multiple recipients tap the Panic button the incoming video is recorded to the network for administrator review. The sender is also notified that multiple complaints were received. Appropriate action can be taken including the removal of the subscriber from the network if multiple occurrences are reported.

In some implementations, the youBounce application can include the following GUI interfaces: Bounce Time (e.g., allows a user to order time a subscription plan ranging from a per second fee to a specific event to an annual contract. Free airtime for the first 5 minutes of usage after which a subscriber is notified by a pop up screen to order more time); Bounce Videos (e.g., provides a subscriber access to all stored videos on their device and in the “cloud,” includes their videos in addition to recorded videos by others); Bounce Networks (e.g., allow subscribers to turn on or off available networks, add or remove contacts, allow recording and view statistics); Bounce Event or Location (e.g., allows a subscriber to view statistics on a particular event or location; default is data relative to device location, however, can be searchable for any location; data can include event name, artist name, date, time, address, admission fee); Bounce Types (e.g., allows a subscriber to activate a specialty bounce including Reflection, Wave, Big, Echo, and Retail); Bounce Channels (e.g., allows subscribers to search keywords in order to find a specific type of video); Bounce Store (e.g., allows subscribers to transport to the retail section of the application, see items purchased and on order); Bounce Settings (e.g., allows subscribers to adjust all settings of the application); Bounce Business (e.g., allows licensees and advertisers to login and view account statistics in addition to providing general information about sponsorships, licensing and cross promotional opportunities; can include information on YouBounce such as company profile, partnerships, employment opportunities and other useful information); Bounce Help (e.g., provides subscribers with a demo video of how to best use the application, frequently asked questions and answers and a help index); and Bounce Panic (e.g., provides a subscriber the ability to instantly report a dangerous situation).

A youBounce application can incorporate a variety of algorithms to effectively bounce video, audio and text. It employs a different set of algorithms to seek out and categorize data. Algorithms are used for both standard and specialty bounces. An algorithm for a standard bounce determines if there is a published event, the number of subscribers at that event, the bounce state of those subscribers at any given moment, the category of the venue, keywords and the location of the venue and the relative position of subscribers within the venue to one another. Algorithms are used in conjunction with the database which has a compiled listed of venues and calendar of events. The equation cross checks venues with events, categories and keywords to determine the optimum method of delivery and type of video to deliver.

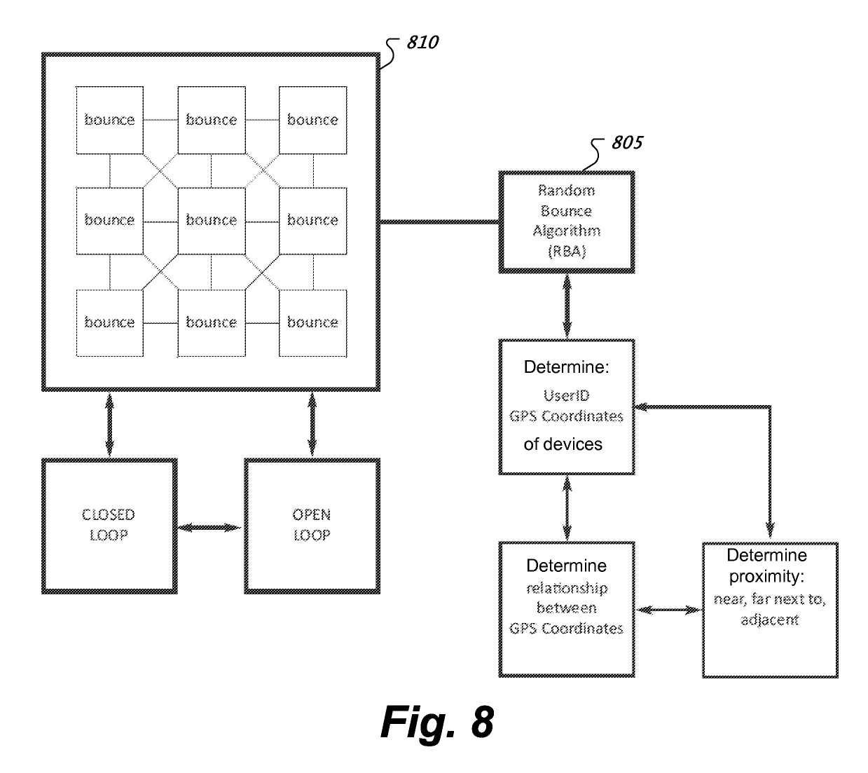

FIG. 8 shows an example of an architecture of a random bounce algorithm 805. A youBounce server process can include a random bounce algorithm 805 can randomly select which devices within a group 810 receive data from other devices based primarily on whether the environment is an open loop or closed loop and the relationship of devices to one another based on their location and quantity within a defined area. In some implementations, the random bounce algorithm 805 allows for non-targeted communication between subscribers in a random pattern as defined by an event, location, category or keyword. In this way, a bounceIn video can be seen by a one or more of the bounceOut viewers associated with a network. In some implementations, the default network is the “everyone” network which includes the “bestFriends” and “Friends” networks as accessed through the “everyone” network. The random bounce algorithm 805 can use information such as user IDs and GPS coordinates of users' mobile device to determine relationships between GPS coordinates, such as proximity of two or more devices and/or whether two or more devices are sharing a commonality. For example, a youBounce server process can use the algorithm 805 to randomly push content streams associated with a commonality to devices that are a part of that commonality. In some implementations, content from a user can be push to one or more randomly selected devices that are located at the opposite side of the stage.

In some implementations, a youBounce server process can include a targeted bounce algorithm to maximize speed and quality of bounces between defined targets. A target is a specific member(s) of the network. Targets include bestFriends and Friends. The “everyone” network is not defined as a specific target.

In some implementations, a youBounce server process can include a gravitational bounce algorithm which can be utilized for a bounceWave or bounceEcho and detects the total number of devices within a given location, their proximity to one another and current bounce state in an effort to create a defined pattern utilizing those devices. The algorithm sends an invitation to participate in the specified event in a timed pattern. The algorithm can gravitate to areas of highest density from a single or multiple starting point(s). The effect continues to increase in size (becomes heavier) as it attracts more users at a faster pace and greater distance. This effect continues until the algorithm has played itself out or gravity has collapsed upon itself. Gravitational algorithms can be organic (random shape), defined (square, radial, line) or patterned (up, down, left, right, inward, or outward).

In some implementations, a youBounce server process can include a pattern recognition algorithm which can be used in conjunction with a gravitational bounce algorithm. It allows for the complete manipulation of data across multiple devices during a bounceWave or bounceEcho. For example the algorithm can take a video and display it across 10 or 1,000 devices. It can change the color of the video, split the video over the total number of devices and turn the video into shapes such as flowers, squares, circles and organic shapes.

In some implementations, a youBounce server process can include a location algorithm to determine the location of users to themselves, to their location, to each other and their interaction with each other.

In some implementations, youBounce allows subscribers to automatically import contacts from their address book located within their devices. At any time during or after the import a subscriber can categorize these contacts into a network such as BestFriends or Friends. In some implementations, youBounce allows subscribers to import existing contacts from Facebook, You Tube and Twitter in addition to posting videos to these sites either manually or automatically—depending on a subscriber's preference.

Some implementations can include an interface, database and control mechanism for the instant and simultaneous exchange of digital data (video, audio, text data, virtual or holographic) in real time over secured wireless and WiFi networks between a host and a plurality of users on mobile devices that contain a lens or lenses.

Some implementations can allows users within a video interface over a secured network to take, record and share video, audio and text between mobile devices such as a smart phone or tablet running either Android or iOS software over a wireless and or WiFi network.

In some implementations, a video interface can be configured to enable a user to record video directly to his mobile device or network server and simultaneously stream that video and record it, if desired, to the network in real time. The video interface can be configured to enable a user to record, zoom, rewind, fast rewind, forward, fast forward, or stop a recording. The video interface can be configured to enable a user to select the quality of the recording, ability to name the video, determine where to save the video, view video length, or enable a flash.

In some implementations, the act of taking, sharing, viewing and recording data (video, audio and text) is called a “bounce.” More specifically a “bounce” can be defined as the instant and simultaneous transmission of data over or through a network. There are several bounce states including primary states: in, in Rec, out, outRec, on, and off. There are several subsets or secondary states of “bouncing” including: bounceEvent, bounceReflection, bounceBig, bounceWave, bounceEcho, bounceChannels, bounceCloud, bounceBuy, bounceRetail, bounceNetwork, and bounceLocal. These secondary sets require the implementation of the primary bounce states.

In some implementations, a “bounce” is a multi-state event that includes: bounceIn—a state whereby a user transmits data over the network and allows other users within the network to view that video content; bounceInRec—a state that allows a user to transmit data over the network which allows other users within the network the option to record that data either as it streams in real time or saved to the network (bounceCloud or bounceChannel) for a limited time for future recording; bounceOut—a state that allows users to view streaming or temporarily saved, but not recordable data on the network. Users can swipe their mobile device and scroll from video to video as they are played. Additionally, users can view video from within the bounceCloud based on certain permissions (BestFriends, Friends or Everyone). Lastly, users can view video based on categories as stored within the bounceChannel; bounceOutRec—is a state that allows users viewing video to record that video to either their mobile device or bounceCloud account. The ability to record this video is a result of the permission set by the user taking the video (bounceIn protocol); bounceOn—is an inactive state whereby no video or recording action occurs however, the user is registered within the network, appears within the database as On but inactive and whose GPS coordinates are known; and bounceOff—is a state of inactivity whereby users are off the network but still have the ability to take and record video to their own mobile device.

In some implementations, a “bounce” can only be in a single primary state at any given time on a single device. However, for the system to work it requires a plurality of users in any infinite number of states at any given time so long as the state of that particular user is opposite to the opposing state. For example if a user is Bouncing In—they cannot be Bouncing Out. Additionally, if a user is Bouncing In and there are no other users Bouncing Out then that video will not be viewed (unless recorded and saved to the network for future viewing). Additionally, if a user is Bouncing Out and there are no users Bouncing In—then the user Bouncing Out will not see any video (unless recorded and saved to the network). This same principal holds true for all other bounce states: If User A is bounceIn than User B through infinity is bounceOut; If User A is bounceInRec than User B through infinity is optional bounceOutRec.

In some implementations, the video interface also includes a series of “switches” that users can activate at any time to share, record, allow recording and viewing of video instantly between other users of then network individually or in plurality in either a targeted or random manner.

In some implementations, the “switches” include a primary and secondary “switch.” The primary “switch” is a toggle that allows users to tap into (bounceIn) the network to share their video, tap out (bounceOut) to view videos on the network, to tap in and record into the network (bounceInRec) and to tap out and record (bounceOutRec) incoming video set to bounceInRec. Additionally the “switch” can be set to bounceOn which allows users to be registered on the network regardless of if they are bouncingIn and bounceOut which allows a user to take video without being registered on the network. The secondary “switch” enables users to select network setting. These settings can include three primary states: BestFriends(network), Friends(network) and Everyone(network). BestFriends(network) allows users within in the network to instantly select all “Best Friends” individually or simultaneously in any combination or sequence and stream or view video only to or by those targets. BestFriendsNetwork is considered to be an extremely private and secured network. Friends(network) allows users within the network to instantly select an unlimited number of “friends” in any combination or sequence and stream or view video to and from any of those targets. When users select this option their BestFriends are also included. Users can unselect this option and remove any or all BestFriends from the Friends(network). Users determine their “friends” through their address book, manual input or importing of data from 3rd party sources such as Facebook, Twitter or You Tube. FriendsNetwork is considered to be a private and secured network. Everyone(network) allows users within the network to instantly connect to any other user registered and active on the network in a randomly selected manner and stream or view video from any of those targets. When users select the EveryoneNetwork, BestFriendsNetwork and FriendsNetwork are also instantly and automatically selected. Users can deselect at any time BestFriends and Friends. EveryoneNetwork is considered a public but secured network.

In some implementations, network connections can be established through a system of private wireless networks, private WiFi networks and peer to peer connections over WiFi networks. These connections can work in conjunction or independently of one another and are dependent of lines of site, geographical coordinates and type of event being viewed or recorded. In addition these connections require the use of routers and servers on a localized, regionalized, nationalized, or globalized basis dependent on lines of site, geographical coordinates and type of event being viewed or recorded.

In some implementations, the system relies on bouncing to either defined or random targets within the network. Targets are defined as users within the network as well as their state on the network. Defined targets are connections between specific users as established by users of the network. Random targets are connections between users other than those defined as specific.

In some implementations, a bounce relies on a single or series of algorithms that determine connections between users within the network. These connections involve the location of users to one another, to a defined public or private space, to a public or private event or to a particular subset or secondary bounce state. An example of a defined target would be when User A wishes to transmit video specifically to User B or Users B, C, D, E. Though the video is transmitted in real time over the network—only those targeted have the ability to view the video transmission. Users B, C, D, and E can be in any bounce state prior to viewing the video. Once the transmission is sent these users are notified of the incoming stream and can at their option accept, reject, view now or view later that data stream. User A is notified which of the targets is viewing video if singular or the number of targets viewing the video if more than one. An example of a random target would be when User A wishes to transmit video to everybody within the network. The video is transmitted using an algorithm that sends the video to users in the bounceOut state in a random manner. The algorithm can send the video to 1 or a plurality of users and is in part determined by the GPS coordinates between users, location of the users, number of users on the within a defined boundary and the content of the video. User A cannot control who receives and/or views the incoming video stream. User A is informed only as to how many other users are viewing their video. Users who are bouncing out to the “everyone” network are not notified of incoming video as it is automatically visible on their mobile device.

In some implementations, the system relies on a database to control, regulate, disseminate, save and record data by and amongst users and events. The database is accessible only by the administrator. However, third parties such as advertisers, sponsors and promoters have limited access to the database through both computers and mobile devices in order to check and track the status of their goods and services as they relate to income and performance within the network. The database also allows the administrator to track the GPS coordinates of all users within the network while on the network for the purpose of sending/receiving video, advertising, and merchandise. The database can store user content such as video, audio, and/or text. The database can store information for advertising, sponsorships, or e-commerce.

In some implementations, a document can include video, audio and advertising which are created, gathered, formatted, processed and presented to other users within the network in real time. The defined elements include unique video by a user, advertising relating to that video, it's location, category of video defined by location and content, a database that categories the content and streams it to others within the network. In some implementations, one or more distinct media types are utilized including video, audio and text both created and generated from a host and a plurality of users. In some implementations, the video and audio that is created is combined with data from a database that is able to categorize and send text to a user or plurality of users including the location of the content and subject matter of the content before, during or after the content has actually been created.

Some implementations can include a color scheme that allows a plurality of users to know if they are streaming video into or out of the network, on or out of the network or recording video into our out of the network. The color scheme consists of green, pulsing green, red, pulsing red.

Some implementations can include hypermedia that relates to the ability of a user to click on a link from a third party such as an advertiser in order to either obtain more information or purchase products and services. This hypermedia ability can be implemented within the network. A user however can link to external sites using the product & service described herein. In some implementations, multiple links are organized in a particular manner based on an event, a time and a location. These links are accessed in two ways, either firstly as they occur between videos (bounceOut) and available at any time from the menu button which based on a published or non-published event can change from Event to Local network settings. In some implementations, links are automatically created any time a user searches the database insofar as upon conducting a search video relative to the search is displayed. In some implementations, upon conducting a search brings up video rather than text links. In some implementations, links are within the site only and are relative to content that is created in real time. Some implementations allows a user who conducts a search to edit the link at any given time thus bringing up additional links. Links are only available as long as video being created in real time is being shared within the network.

In some implementations, the network relies on a database that includes a variety of specific fields which allows for the coding and categorizing of content. This content can then be combined into any combination to provide a set of results. The database resides on servers accessible to the patent holder and with limited access to third parties. The patent holder can add, remove, control and structure data accordingly within the database. The database can include one or more of the following information categories: user defined information (e.g., name, address, e-mail, date of birth, or billing information such as type of payment, account number, expiration date, or security code); event defined information (e.g., location address, phone number, website URL, date, time, seating capacity, category, one or more featured attractions, or promoter); location defined information (e.g., location address, phone number, website URL, current date, current time, category of location, or special features of location); and advertiser defined information (e.g., company name, company contact, address, phone, alternate phone, fax, e-mail, website, licensing agreement, fee paid, ad number, ad video, ad length, ad product, product link, product price, product size, product color, ship from, ship to, or pick up). In some implementations, a database process can generate statistical data for each advertiser including location of event, number of ads displayed, number of links selected, cost per ad, quantity and type of merchandise purchased, gross dollars generated, net dollars generated and purchaser ID.

In some implementations, a youBounce application user interface relies on two distinct elements; the first being a video interface which allows a user to record video to their device and includes options for how that video is taken, the second element being a network interface that allows for the recording of video into a network and directly to a plurality of users. While the two element are integrated, they each have distinct and very different functions. In some implementations, a youBounce application provides the ability to take video (function 1—capture data from a plurality of devices) and search a database for video (function 2—search data as it is streamed to a central database). A youBounce application can collect metadata such as recording, length of recording, subject matter are defined either automatically by a central database or input manually by a user then sent to a database.

Some implementations allows for real time creation and management of a database by a plurality of users as they enter, exit and search the network. At any given time a user can create video. This video is cataloged into the database based on a predefined set of criteria. Those criteria are processed and the results are displayed within a search feature in the applications. The data collected is dynamic and changes based on a whether or not a user is in the database or if they have allowed the database to “capture” and store their information which can then be shared by anyone or specific targets within the network.

In some implementations, subject matter being created such as video is processed according to a predefined arrangement of interrelated hierarchical processes and the results displayed as data such as video as it is being created from within the network.

In some implementations, a database process creates uniquely generated content that is then displayed within a custom style sheet and displayed on a single or plurality of mobile devices. This style sheet which is created by the database can be manipulated and changed in real time either by a user, plurality of users or dynamically as users enter or exit the network. Style sheets are utilized within the menu and search capabilities of the application. Additional style sheets include network targets such as the creation and removal of contacts from within the network relative to a user's preference of adding or deleting contacts out of their preferred network.

In some implementations, once data has been input manually into a database or created dynamically by a user or plurality of users within the network, the results are visually displayed in video (with or without audio) and text. Display features can include video as it is created, video related feedback (video recording time, length of video, focal (zoom) length of lens, state of recording (recording, play, fast forward, super-fast forward, rewind, super-fast rewind, stop, pause, video quality, video light) network feedback (number of users relative to a location or event, type of network (E, BF, F), state of capture (bounceIn, bounceOut, bounceInRec, bounceOutRec) and other network states (bounceReflection, bounceEcho, bounceBig, bounceWave). Additionally, each recording contains a tag at the end of each video as it pertains to the location, category and user ID.

In some implementations, an operator interface includes two primary operator interfaces including a front end interface and a back end interface. The front end interface is controlled by a user or plurality of users within the network. This interface allows an operator to take video both outside of and within the network and to record video (defined as both video and audio) at their discretion to others in a random or specific manner—called bouncing. In addition, a user or plurality of users can view video produced either by them or others from within the network. Users have the ability to “slide” from video to video and to record this video to their device or public or private channels within the network. The graphical user interface is not vertical or horizontal specific and is automatically adjusted according to the relative position of the device (vertical or horizontal). The back end interface is a database that requires both manually input and dynamically generated data. The back end interface can be accessed from a computer or a mobile device relying on wireless or WiFi connections.

In some implementations, a youBounce application can include force feedback interaction (FFI) to interact with the graphical user interface on the front end using tap technology developed by others. FFI includes tap, swipe, pinch in, extend out, rotate, scroll and keyboard for typing for mobile devices. The back end interface relies on mechanical input using a keyboard and mouse.

In some implementations, a youBounce application can include tactile based interaction of the front end graphical user interface in the following manner. A users or plurality of devices sent a signal upon the implementation of a bounce option (e.g., bounceReflection, bounceWave, bounceBig, bounceEcho) which vibrates the device, or changes the color of the interface based on the incoming signal or both. Each of the bounce options has its own color scheme for incoming and outgoing video messaging. Upon receiving the signal a user can opt to accept or deny the signal. For a standard bounce—the network interface changes color based on the whether the signal is incoming (bounceOut) or outgoing (bounceIn) and state of bounce (recording or not recording).

Some implementations can include a playback of recorded user events interface. Specific events by a user dictate what and what isn't saved, recorded and regenerated in terms of graphical user interface. Typically, the application which utilizes a back button can always refer to previous actions by a user. Additionally for newly created data the application requires basic input such as bouncingIn or bouncingOut or conducting a search—both of which generate unique content. Additionally Users can use an interface to pull up BestFriends and Friends network sets utilizing a single “switch.” The search feature can automatically generate using logical algorithms words based on initial input by a user. For instance, if searching for the general term concert—while typing con—logical words beginning with these letters and pertaining to the context of the application would be generated—thus limiting how much a user has to type.

Some implementations can include an adaptive to user skill level mechanism in so far as upon the launch of the application for the first time a tutorial is played. Every time a feature is used for the first time a micro tutorial or blurb as to the function is displayed. After a function is used—this auto created feature is disabled. However, at any time a user can go to the help menu to reactive this setting or get information on a particular feature of the application.

Some implementations can generate context sensitive information. For example, information once generated into the network can be coded with the user ID, location coordinates, creation timestamp, attributes of the location, and special activities at the location. Users at a particular location are then provided with information (data) as it relates to that specific location by default. Users however can search anything outside of that location and can receive results accordingly. For example if a user is at a concert venue and they bounceIn or bounceOut video data can by default be set to send and receive from within that venue first and then externally outside of the venue. The data set can include the name of the venue, artist, date, time, address, category of music. A subset of relatable data can be provided using links. This data includes other events at the venue, more information on the artists, additional shows by the artist and available merchandise. Aside from this information being generated as it occurs, at any time a user at the event (and those outside of the venue) can select the event button to pull up a variety of information.

Some implementations can include on-screen video or audio system interface. The interface requires manual manipulation of a set of buttons to operate the video aspect of the application. These buttons are tap sensitive and are color coordinated. In addition, the interface of the application as it pertains to the video taking portion can vary slightly by mobile device. Each mobile device has its own unique video taking interface. Without infringing on this interface, the application can mimic as close as possible the interface.

Some implementations can include multiple diverse systems whereby a user within the network can select an option to transmit their data set to defined plural systems. Users can also select to interact with these data systems which are received from multiple sources. Systems being mobile devices and various networks (E, BF, F). An example of this is a bounceOut from the “everyone” network whereby a single user is receiving data from multiple users devices and interacting with that data.

Some implementations can include a mode switching interface in regards to the bounceBig feature of the application which allows a user for a fee to transmit video from their mobile device to a large monitor typically located within a predefined location such as a venue or retail environment or home television.

Some implementations can include a video traversal control interface which allows video data interaction by and between users on the network in coordination with a database.

Some implementations can include an indexed control interface which allows for video program segments to be indexed. Every time a video is taken within the network the coordinates of the device taking the video are used to determine the potential category of the video. Using a database which includes a list of events, including date, time and associated activity the application automatically generates an index of searchable keywords. These keywords are meta tagged and allow all video to instantly be searched. If there is not an event based on a certain date and time the application can still using gps coordinates make assumptions as to a keyword index. For example if a video is taken in Times Square in New York city it would be tagged with the following keywords “New York,” “Times Square,” “‘Name’ of Retailer,” “tourist attraction” and “hustle & bustle.” Indexing can be accessed using the search feature in addition to bounceChannels.

Some implementations can include video segment editing or sequencing interface insofar as that every time video is streamed to the network its sequence is viewed differently by users within the network. This is because of a set of algorithms in which different users can rarely if ever experience the same sequence of videos due to their location, category and search. For example even if two people were at the same venue, sitting next to one another and typed in the same keywords—the algorithm would randomly bounce video from different sources. The odds of the same video appearing at the same time in the same sequence would be small. However, that said, the odds of near similar videos and sequences is increased if fewer people are in the network. Some implementations can include effects or transitions interface. Between every video is a transition in which a 2-3 second placeholder is provided that allows for the insertion of advertising. The cut between videos is a straight cut.

Some implementations can include audio user interface. The video control portion of the application allows for limited audio controls including on/off and audio volume. As such a user can opt to take video with or without sound. During playback a user can adjust the volume. However, a user cannot adjust the volume while taking a recording which is set to a default standard control. Some implementations can include an audio input for on-screen manipulation. The application allows for specific commands to be input by voice when pressing and holding the bounce button. These commands include: bounceIn to bounce in. bounceOut to bounce out. bounceInRec to bound in and record a video to the network, bounceOutRec to bounce out and record an incoming video. Search “x” to search a particular video. Bounce“Network” to bounce to a particular network type such as bounceEveryone, bounceBestFriends, bounceFriends, bounce“Name.” Additional commands include bounce options: bounceBig, bounceWave, bounceEcho, bounceReflection, bounceReflection and bounceCloud.

Some implementations can include an interactive network representation of devices insofar as a user within the network can select with whom to share their video data (Everyone, bestFriends, friends) and if those recipients can record to their device or “cloud” account that particular video. On the back end the interface is controlled by an operator who can manipulate the arrangement of data and its distribution. Examples of this would be a bounceWave, bounceBig and bounceEcho.

Some implementations can include network managing or monitoring status insofar as the back end interface is controlled by an operator who through the use of a database can view, track and measure the activity within the network. This activity includes the location of users (gps coordinates), bandwidth usage (streaming of video), types of streaming (bounceIn(Rec) or bounceOut(Rec), advertising related data, search related data (i.e. most popular searches, categories of searches, location of searches), and other metrics. The operator can also view financial information in regards to licensing and advertising. Additionally, third parties can log in and view specific information related to their accounts. There is also a panic button which allows an administrator to monitor the security of the site and send requests or remove users deemed dangerous. The administrator also uses the interface to manually input keywords in regards to gps coordinates and event information such as date, time, location, category and associated keywords.

In some implementations, a youBounce application can include an access rights to interactive controls mechanism. The front end user interface available to users is capable of establishing, modifying and observing the function of processes enabled by other users and thus devices. In addition, the back end user interface can at any time see the activity of one or all of the users in the network. The database can track their location relative to the device, usage on the network including video viewing, video sending, purchase of merchandise, interaction with advertising, interaction with other users on the network, time on the network, on which day the network was accessed, network options (E, BF, F), user settings and search queries.

In some implementations, a database process can control what information is sent to a user or plurality of users including denying access to the site through a panic button, and can auto detect and reset default settings based on a location or an event. In other words, the controller takes over a user's device when that user enters into a particular event. Certain default settings are changed to accommodate the event or location. Items can include the range of the bounce or transmission of data within a defined area only. The operator can also control all devices within a venue in regards to streaming video to them in specific or random sequences.

In some implementations, a youBounce application can include a Floor Control element in regards to the bounce features including bounceReflection, bounceBig, bounceWave and bounceEcho. A bounceReflection allows a single user within a venue to control all devices within the venue with permission insofar as streaming video to a plurality of devices. The other options allow one user to target other users within a defined space in a random sequence with permissions.

In some implementations, a youBounce application can include Graphical or Iconic Based elements whereas the action on a single device is related to another device via a visual cue. For instance a bounceIn on one device can show as a bounceOut on another device. The colors can reflect this action (green to green pulse respectively).

In some implementations, a youBounce application can include Focus Control of Multiple Diverse Workspace Objects insomuch as the video created can be edited (basic edit) by user taking video. Additionally, the administrator can alter the subject matter with the inclusion of advertisements or special effects in relation to bounceWaves, bounceEcho's, bounceReflections and bounceBig's.

In some implementations, a youBounce application can include Data Transfer Operation Between Objects however this process is automatic as in when the bounce interface goes from the center of the screen to the top corner or adjusts accordingly if the device is in either the vertical or horizontal positions.

In some implementations, a youBounce application can include On-Screen Link or Communication as standard operating and navigational procedure from any mobile device. The application does this through a color scheme within a device between windows and commands and between a plurality of devices in the same manner. For example the application has a different visual color set for voice commands, network types and bounces. Additionally every screen has a text heading.

In some implementations, a youBounce application can include Pop-Up Control as standard operating and navigational procedure from, to and by any mobile device and between the database and devices. An example of this is if a user on the network is bounceIn video and an artist of stages performs a bounceReflection this user would receive a notification of an incoming video by “bounceInReflectionUserName.” This same principal applies to billing, confirmation of order and bounces to specific targets.

In some implementations, a youBounce application can dynamically generate one or more menu items insofar as a defined location and/or event can change the menu and submenu to include specific information about an event or location. For example, a user is at a stadium for a baseball game the menu can reflect this information and the submenu can reflect more detailed information. This can change if the users attends an area where a hip hop concert is playing. The structure and organization are the same—however, the content is different.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Particular embodiments of the subject matter have been described. Other embodiments are within the scope of the following claims. For example, the actions recited in certain claims can be performed in a different order and still achieve desirable results. As one example, the processes depicted in the accompanying figures do not necessarily require the particular order shown, or sequential order, to achieve desirable results.

What is claimed is:

1. A method performed by one or more processes executing on a computer system, the method comprising:
establishing communication with a plurality of mobile devices sharing a common characteristic, each mobile device associated with a respective user;
receiving from a first mobile device sharing the common characteristic (i) a video segment captured by the first mobile device and (ii) a request to make the captured video segment available for viewing by other mobile devices with which communication has been established;
receiving from a second mobile device sharing the common characteristic a request to view the captured video segment received from the first mobile device; and
transmitting to the second mobile device the captured video segment received from the first mobile device.

2. The method of claim 1, wherein the common characteristic shared by the plurality of mobile devices comprises a common geographic region.

3. The method of claim 2, wherein the common geographic region comprises an event venue.

4. The method of claim 1, wherein the common characteristic shared by the plurality of mobile devices comprises participation in a predetermined activity.

5. The method of claim 4, wherein the predetermined activity comprises a live performance.

6. The method of claim 4, wherein the predetermined activity comprises engaging in an online activity relating to a common theme.

7. The method of claim 6, wherein the online activity relating to the common theme comprises one or more of online searching, sending email messages, sending text message, or engaging in social network activities.

8. The method of claim 1, wherein receiving the request from the second mobile device and transmitting the captured video segment to the second mobile device occurs substantially in real time.

9. The method of claim 1, comprising: providing advertisements to the plurality of mobile devices.

10. The method of claim 1, wherein the common characteristic shared by the plurality of mobile devices comprises a common event, the method further comprising providing data to coordinate display of content on at least a portion of the mobile devices during the common event.

11. A method performed by one or more processes executing on a mobile device, the method comprising:
establishing communication with a computer system configured to facilitate sharing of video segments among a plurality of mobile devices having a common characteristic;
using, when in a first user mode, a video capture function of the mobile device to capture a video segment and transmit the captured video segment to the computer system for real time, or near real time, viewing by other mobile devices sharing the common characteristic; and
requesting, when in a second user mode, from the computer system to view in real time, or near real time, a video segment captured by another mobile device sharing the common characteristic.

12. The method of claim 11, wherein the common characteristic shared by the plurality of mobile devices comprises a common geographic region, a predetermined activity, or a combination there of.

13. The method of claim 12, wherein the common geographic region comprises an event venue.

14. The method of claim 12, wherein the predetermined activity comprises a live performance.

15. The method of claim 14, wherein the predetermined activity comprises engaging in an online activity relating to a common theme.

16. The method of claim 15, wherein the online activity relating to the common theme comprises one or more of online searching, sending email messages, sending text message, or engaging in social network activities.

17. The method of claim 11, comprising:
providing a user interface to switch among a plurality of different content streams associated with the common characteristic for display on a screen, each of the content streams being captured by different mobile devices having the common characteristic.

18. A system comprising:
a processor configured to execute computer program instructions; and
a computer storage medium encoded with computer program instructions that, when executed by the processor, cause the system to perform operations comprising:
establishing communication with a plurality of mobile devices sharing a commonality, each mobile device associated with a respective user;
receiving from a first mobile device of the mobile devices (i) a captured content stream that is captured by the first mobile device and (ii) a request to make the captured content stream available for viewing by other mobile devices with which communication has been established;
receiving from a second mobile device of the mobile devices a request to view content associated with the commonality; and
transmitting to the second mobile device the captured content stream.

19. The system of claim 18, wherein the commonality comprises a common geographic region, common event venue, common activity, or a combination thereof.

20. The system of claim 18, wherein the operations comprise providing advertisements to the plurality of mobile devices.

21. The system of claim 18, wherein the operations comprise obtaining information from the mobile devices to determine the commonality.

22. The system of claim 18, wherein the commonality comprises a common event, and wherein the operations comprise providing data to coordinate display of content on at least a portion of the mobile devices during the common event.
